(19) United States
(12) Patent Application Publication
(10) Pub. No.: US 2022/0391978 A1
(43) Pub. Date: Dec. 8, 2022

(54) SWAP ORDER NORMALIZATION

(71) Applicant: Volant Brokerage, LLC, Wilmington, DE (US)

(72) Inventors: Steven I. Givot, Spring, TX (US); John K. Kerin, Park Ridge, IL (US)

(73) Assignee: Volant Brokerage, LLC, Wilmington, DE (US)

(21) Appl. No.: 17/649,163

(22) Filed: Jan. 27, 2022

Related U.S. Application Data
(60) Provisional application No. 63/202,338, filed on Jun. 7, 2021.

(51) Int. Cl. G06Q 40/04

(52) U.S. Cl. CPC G06Q 40/04

(57) ABSTRACT

System and techniques for swap order normalization are described herein. Swap orders are normalized and matched based on a swap ratio of an asset being traded and a denominating asset respectively specified in the swap orders. The normalization enables a single order book to be used without regard to which asset is the traded asset. Maintaining the swap ratio during trades ensures that order intent pre-normalization is maintained after normalization regarding profit improvement.

### CLAIM OF PRIORITY

This patent application claims the benefit of priority, under 35 U.S.C. § 119, to U.S. Provisional Application Ser. No. 63/202,338, titled “SYSTEM AND METHOD FOR SUBMISSION, NORMALIZATION, AND MATCHING OF TRANSACTIONS TO SWAP ONE ASSET OR LIABILITY FOR ANOTHER ASSET OR LIABILITY BOUNDED BY A SWAP RATIO THAT ELIMINATES AMBIGUITY OF THE QUANTITY TO BE SWAPPED” and filed on Jun. 7, 2021, the entirety of which is hereby incorporated by reference herein.

### TECHNICAL FIELD

Embodiments described herein generally relate to data center operations swap order normalization.

### BACKGROUND

Historically, financial transactions in equities, options, futures, foreign currency, commodities, debt instruments, bulk cargo tonnage for shipping commodities, oil pipeline capacity, bulk seats on airline flights, bulk hotel room capacity, trucking capacity, currencies, or assets have taken place in automated or manual trading centers where an order to buy or sell may be submitted with a limit price. These transactions are typically cleared and settled by exchanging a single financial asset (e.g., or liability) identified on the order for an amount of a currency. For example, exchange and over-the-counter trading in stocks in the United States typically state limit prices and Trade Prices in US dollars. In UK markets, limit prices and Trade Prices are typically stated in British Pounds. These trades are cleared and settled by exchanging shares of stock for currency. These traditional orders seek to buy or sell up to a stated quantity of a fungible asset in exchange for a maximum (or minimum in the case of a sell) amount of currency to be paid or received for each unit of the fungible asset bought (sold).

These traditional orders are a special case of a more general class of Swap orders which seek to receive or deliver up to a stated quantity of one fungible asset in exchange for a maximum (or minimum) quantity of another fungible asset for each unit of the first fungible asset. Recently, new asset classes have been created. An example of a new asset class includes digital assets, such as cryptocurrencies, digital securities, digital tokens, stable coins, or other assets where ownership is established via a blockchain or the like. Worldwide, more than 1,000 electronic trading centers exist for trading digital assets. Some offer trading in digital assets that are priced in fiat currency. These trading centers treat digital asset orders as traditional orders by pricing them in fiat currency or assets which are digital representations of fiat currency.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an example of an environment including a system for swap order normalization, according to an embodiment.

FIGS. 2A-2B illustrate an example of matching of two normalized swap orders, according to an embodiment.

FIGS. 3A-3E illustrate an example of a sequence of arriving swap orders resulting in different matching outcomes, according to an embodiment.

FIGS. 4A-4B illustrate sequences of unnormalized swap orders, according to an embodiment.

FIGS. 5A-5B illustrate sequences of unnormalized swap orders (RAWs) and corresponding normalized swap orders (SWAPs) as buy-SWAPs and sell-SWAPs respectively, according to an embodiment.

FIG. 6 illustrates a normalization technique, according to an embodiment.

FIGS. 7A-7D illustrate an example of a first matching pass an inbound swap order is simulated to determine whether to proceed to the second matching pass, according to an embodiment.

FIGS. 8A-8D illustrate an example of a second matching pass performs actual matching of an inbound swap order, according to an embodiment.

FIG. 9 illustrates an example of managing disposition of an inbound swap order after the second matching pass is bypassed or completed, according to an embodiment.

FIGS. 10A-10C illustrate an example of actions resulting from a match, according to an embodiment.

FIG. 11 is a block diagram illustrating an example of a machine upon which one or more embodiments may be implemented.

### DETAILED DESCRIPTION

The use of traditional order handling techniques and traditional matching engines may be appropriate for transactions exchanging fiat currency for digital assets. However, some trading centers offer exchanging one digital asset for another digital asset with no fiat currency changing hands, referred to herein as swapping or a swap. For example, a trading center may offer swap orders to exchange two digital assets such as cryptocurrencies Bitcoin (BTC) and Ether (ETH). Typical order handling and matching engine use is problematic for these swap orders. In the traditional order, one asset is clearly the asset to be bought or sold, and the second asset is clearly the currency to be paid or received. However, when swapping one BTC for ETH, neither asset is clearly the asset to be bought or sold nor is it the currency to be paid or received. This may lead to a price improvement issue. In general, price improvement denotes a situation in which a better price than the price limit may be had in a transaction—for example less of the currency may be used to complete an asset buy order or more of the currency is obtained to complete an asset sell order). In traditional orders, matching engines define actions to take when price improvement occurs in a matched trade. Price improvement affects the quantity of the currency to be paid or received. However, when it is unclear which of the assets is intended to be the currency to be paid or received, it is unclear which of the assets should receive price improvement.

To illustrate the price improvement issue, consider a traditional matching engine for two sell orders involving Company A stock. Order #1 is: sell 5,000 Company A at a limit price of $149.85. Order #2 is: sell 10,000 Company A at a limit price of $150.00 per share. Order #3 is: buy 10,000 shares of Company A stock at a limit price of $150.00 per share. Traditional matching engines will match Order #3 with Order #1 resulting in a trade of 5,000 shares of Company A at a price of $149.85 per share. This matched trade was executed at $0.15 per share better than Order #3 required for the 5,000 shares matched. The difference (e.g., savings in this case) to the party of Order #3—when compared to the price the party was willing to pay—$750.00, or a price improvement of $750.00. Thus, the price improvement is calculated as $0.15 per share multiplied by the 5,000 shares that were matched. The remaining 5,000 shares of Company A stock on Order #3 are matched with Order #1 by the traditional matching engine. This results in a trade of 5,000 shares of Company A at a price of $150.00 per share. Because Order #3 is matched to Order #1 at the limit price specified in Order #3, there is no price improvement for this transaction. After both transactions, Order #3 is complete with total price improvement of $750.00.

In the example above, the matching engine treats the Company A shares as the TradedAsset and US Dollars as the DenominatingAsset—the asset which is used to denominate the price of Company A shares. In swaps, it may be ambiguous as to which asset is the TradedAsset and which asset is the DenominatingAsset. Consider an example of a trading center where the matching engine accepts swap orders between BTC and ETH, and also accepts swap orders to swap between BTC and US Dollars (USD). For this example, the price of one BTC is about 40,000 USD, and the price of one ETH is about 4,000 USD. This implies that the price of one BTC is about 10 times the price of 1 ETH. Now, consider the following orders in this context. The trading center holds a resting Order #11 to buy 10 BTC for a limit price of 40,000 USD per BTC. The limit price of this Order #11 may be considered a SwapRatio that limits the ratio at which USD will be delivered for BTC to 40,000 USD per BTC. A traditional matching engine may operate the same as the previous example for buy or sell orders of BTC denominated in USD. Here, BTC is the TradedAsset, and USD is the DenominatingAsset.

However, when handling swap orders directly between BTC and ETH, the trading center is offering a trade in a SwapPair(BTC,ETH), which may be denoted with a SwapSymbol of BTC/ETH, where BTC is the TradedAsset, and ETH is DenominatingAsset. The trading center may receive Order #15: buy 100 BTC for 1,000 ETH with an implied SwapRatio of 10.00 (1,000 divided by 100). Interpreted in the same manner as Order #11 above, Order #15 identifies that up to 100 BTC is to be bought for ETH at a SwapRatio no greater than 10.00. The same trading center might then receive Order #16: sell 100 BTC for 1,000 ETH at a SwapRatio of 10.00 (1,000 divided by 100). Interpreted in the same manner as Order #11 above, Order #16 identifies that up to 100 BTC is to be sold for ETH at a SwapRatio no less than 10.00.

An issue may arise if a market participant wants to specify ETH as the TradedAsset and BTC DenominatingAsset. Traditional matching engines may offer a second SwapPair(ETH,BTC), for example, with a SwapSymbol of ETH/BTC. The SwapSymbol ETH/BTC may have its own resting order book that is separate and distinct from the resting order book managing the SwapSymbol BTC/ETH. As used herein, a restring order book is a data structure holding a set of resting (e.g., pending) orders that are not fully matched by a matching engine. A traditional matching engine does not support matching trades involving a swap order in the ETH/BTC resting order book and a swap order in the BTC/ETH resting order book. That is, trades are matched within only one resting order book. This behavior is a limit of traditional matching engines.

It is possible, or even likely, that swap orders in the BTC/ETH could be matched against ETH/BTC. The mechanism a trading center with a traditional matching engine may use to support matching swap orders between two different resting order books may include support of individual swap orders sent by risk-taking arbitrageurs. Arbitrageurs face considerable risk because it is possible that there are competing arbitrageurs trying to do the same thing. Thus, the arbitrageur's swap orders may receive a response to one swap order that is not proportional to the response received to another swap order. Because of this risk, arbitrageurs will generally refrain from orders unless a considerable profit opportunity exists.

The market efficiency of handling swap orders of assets in different resting books depending upon the denominating asset determination (e.g., different resting books for BTC/ETH and ETH/BTC) is poor. If arbitrageurs profit, the profit comes at the expense of others trading in the assets (e.g., BTC/ETH and ETH/BTC). Market efficiency for swapping such assets may be significantly improved by combining swap orders into a single SwapPair with a single SwapSymbol managed in a single resting order book at a trading center. However, this presents an additional issue. If the swap orders for such assets are combined into a single resting order book, there is ambiguity as to which asset is the TradedAsset and which asset is the DenominatingAsset.

To address the issues noted above, swap order normalization may be used. Swap order normalization enables swap orders for two assets to be combined in a single resting order book. In an example, the entity making the swap order (e.g., the swap order sender) may define which asset is the TradedAsset and which asset is the DenominatingAsset. Accordingly, the swap order sender defines (e.g., specifies) which asset is matched to the full stated limit in the order, the other asset able to receive a price improvement. Consider a swap order to buy 1000 AAA for 2000 BBB, where the swap order sender is trying to completely liquidate a position of 2000 BBB. In this situation, the swap order sender wants BBB to be the TradedAsset and AAA be the DenominatingAsset. If the swap order is completely matched, 2000 BBB will be delivered. If there is price improvement, the swap order sender will receive more than 1000 AAA. Now, consider the same swap order to buy where the swap order sender is trying to acquire exactly 1000 AAA and may hold more than 2000 BBB. In this situation, the swap order sender wants AAA to be the TradedAsset and BBB be the DenominatingAsset. If the swap order is completely matched, 1000 AAA will be received. If there is price improvement, the swap order sender will deliver less than 1000 BBB.

In this context, traditional matching engines may be modified via normalization of orders from a RAW format to a SWAP format, the SWAP format including an indication of which asset is a TradedAsset and which asset is a DenominatingAsset in the SWAP format order. This normalized order (e.g., the SWAP format order) may then be stored in a resting order book. The matching engine is configured to match normalized orders in the resting order book, including respecting the TradedAsset or DenominatingAsset specified in entries of the resting order book. This system may be called a Normalization And matching engine (NAME). NAME address the issues of traditional trading center matching engines while enabling entities placing orders to determine which is the TradedAsset and which is the DenominatingAsset.

Unnormalized (RAW) swap orders conform to traditional swap orders being sent to trading centers. RAW swap orders may be expressed in various formats. The example format used in this document is, buy 1000 AAA for 2000 BBB. This format uses an implied SwapRatio that, from this example, can be calculated as 2.00 (2000 divided by 1000). This format is equivalent to buy 1000 AAA for BBB SwapRatio=2.00. NAME normalization converts each unnormalized RAW swap order into a normalized swap order (SWAP order) before being used by the NAME matching engine. Normalized swap orders for two assets may be combined (e.g., in the resting order book) for any two assets regardless of which assets is the TradedAsset and which asset is the DenominatingAsset. Further, the normalization enables the entity creating the order to specify which asset is the TradedAsset and which is the DenominatingAsset.

The NAME matching engine is configured to recognize the swap order sender's choice of TradedAsset or DenominatingAsset and matches in compliance with that choice. Here, each normalized swap order specifies the swap order sender's choice of TradedAsset and DenominatingAsset. Once the NAME matching engine matches orders, the orders may be completed in a manner similar to traditional matching engines. Additional details and examples are provided below.

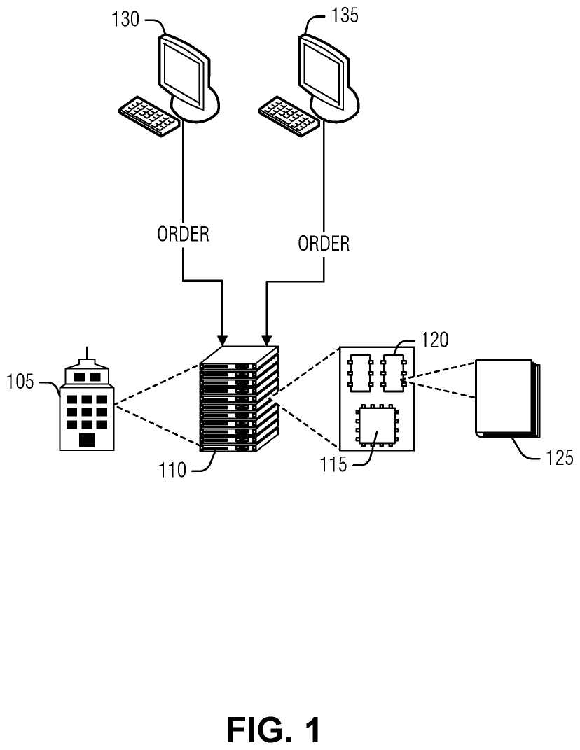

FIG. 1 illustrates an example of an environment including a system for swap order normalization, according to an embodiment. As illustrated, a trading center 105 includes a data center 110. The data center 110 includes interfaces to connect to entities making orders, such as entity 130 and entity 135. The data center also includes computer hardware, such as processing circuitry 115 and memory 120. As explained below, the processing circuitry 115 and memory 120 may be configured to implement normalization of swap orders as well as implement a matching engine. The data center 110 may also provide hardware or software to perform network operations, to implement clearance and settlement, auditing, backup and recovery, or external data feeds.

The processing circuitry 115 is configured to implement normalization (referred to herein as the NAME Normalization Process) of raw swap orders into normalized swap orders. Here, each valid inbound raw swap order is converted into a normalized swap order. The normalization includes converting RAW format orders into a SWAP format orders, providing a ranking technique for the SWAP format orders, and specifying the TradedAsset or the DenominatingAsset in the SWAP format orders.

Converting the RAW format to the SWAP format may include three elements: 1) ordering symbols of assets; 2) providing a ranking criterion for the assets; and 3) assigning a TradedAsset or a DenominatingAsset indication to one or more symbols. The first element involves examining the symbols in the RAW format and ordering the symbols into a predefined order (e.g., ascending alphanumerical order). Thus, if the symbols are already in the predefined order, the symbols are copied to corresponding fields in the SWAP format data structure. Otherwise, the symbols are ordered and written to the SWAP format in order. A SwapPair a pair of assets (e.g., BTC and ETH) whose symbols are presented in ascending alphanumerical sequence. Thus, a SWAP format with two symbols—which is typical in a swap order-ordered in ascending alphanumerical order is a type of SwapPair, with SWAP. Symbol1 and SWAP.Symbol2 are in an ascending sequence.

Elements corresponding to the symbols are modified to follow the symbol. Thus, if the RAW format has a quantity (Qty) and a Side (e.g., buy-side or sell-side) corresponding to a symbol, if that symbol is moved from a first position to a second position in the sequence when ordered, the Qty and Side also move. For example, If RAW.Symbol1 (e.g., the first symbol in the RAW format) and RAW.Symbol2 are in ascending sequence, then Symbol1, Symbol2, Qty1, Qty2, and Side are copied from RAW into SWAP. Otherwise, RAW.Symbol1 and RAW.Symbol2 are in a descending sequence. Here, the Symbols, Quantities, and Side are not simply copied into corresponding positions in the SWAP format, but rather SWAP. Symbol1 is set to RAW.Symbol2, SWAP.Symbol2 is set to RAW.Symbol1, SWAP.Qty1 is set to RAW.Qty2, SWAP.Qty2 is set to RAW.Qty1, and SWAP.Side is changed to the opposite of RAW.Side (i.e., buy to sell or vice versa).

Once the symbols and corresponding fields are ordered in the SWAP format data structure, the processing circuitry 115 is configured to determine how a matching engine should rank, for matching priority, each SWAP format data structure when placed in the resting order book 125. The resting order book 125 is a data structure with two distinct sub-structures called sides. The buy-side holds buy-swap orders, and the sell side holds sell-swap orders. The resting order book 125 includes a ranking technique used to select which order to match next called matching priority. An example ranking is price-time priority. Price-time priority ranks orders primarily (e.g., first) by limit price and secondarily (e.g., second) by time of receipt. Buy or sell orders with a higher or lower limit price respectively are ranked ahead of buy or sell orders with a lower or higher limit price. Among orders with the same limit price, orders which arrived earlier would be ranked ahead of orders that arrived later.

A naïve price-time priority generally is insufficient for swap orders because swap orders generally do not have a limit price. Rather, each SWAP for SwapPair(AAA,BBB) has a SwapRatio that limits the quantity BBB that will be exchanged for AAA. The SwapRatio may be included in the RAW format order explicitly (e.g., as a field designating the ratio) or implicitly (e.g., dividing Qty1 by Qty2). For many of the following examples, the RAW object for a buy is represented as: buy 1000 AAA for 2000 BBB. Here, the side is “buy,” the first quantity (Qty1) is 1000 and corresponds to the first symbol AAA, the second quantity 2000 corresponds to the second symbol BBB. In this example, the swap ratio is implicit, being Qty2 divided by Qty1, which yields a SwapRatio of 2.00 (2000 divided by 1000).

The processing circuitry 115 is configured to set the SWAP object SwapRatio field based on the ratio from the RAW object. Following the previous example, the processing circuitry 115 is configured to set SWAP.SwapRatio equal to SWAP.Qty2 (e.g., the total quantity of SWAP.Symbol2) divided by SWAP.Qty1 (the total quantity of SWAP.Symbol1). The SwapRatio is useful because it is dependent on whether RAW.Qty1 and RAW.Qty2 are switched when the SWAP object is created. This enables each SWAP to be ranked in a manner equivalent to a traditional order ranking based on a limit price. In an example, a SWAP object in the resting order book 125 is first ranked based on its SWAP.SwapRatio and second ranked (e.g., the first ranking is equal) based on the SWAP.TimeOfReceipt field. This ranking technique may be called SwapRatio-Time priority.

The third element is providing a way for the entity (e.g., entity 130) to specify which asset in the order is the TradedAsset and which is the DenominatingAsset. In an example, a flag, bit, or other indicator may be included with the symbol to select one or both of the TradedAsset or DenominatingAsset. However, an elegant solution is to specify that the first symbol in the RAW object is the TradedAsset and the second is the DenominatingAsset. In an example, NAME, RAW.Symbol1 defines the TradedAsset that the entity 130 selects to control matching engine behavior. The other asset is, by default, the DenominatingAsset.

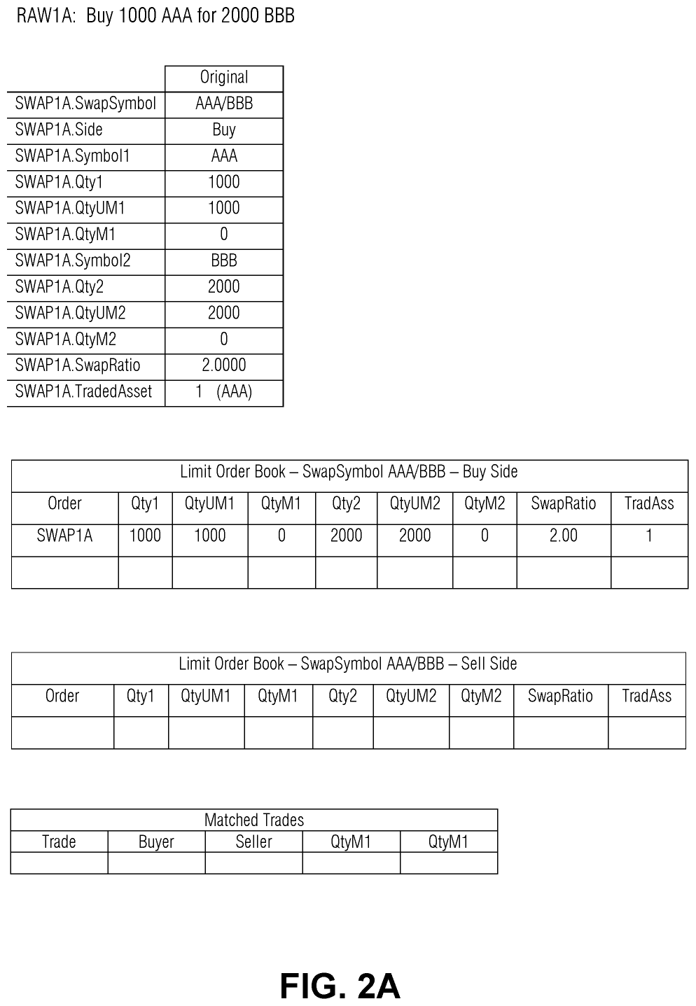

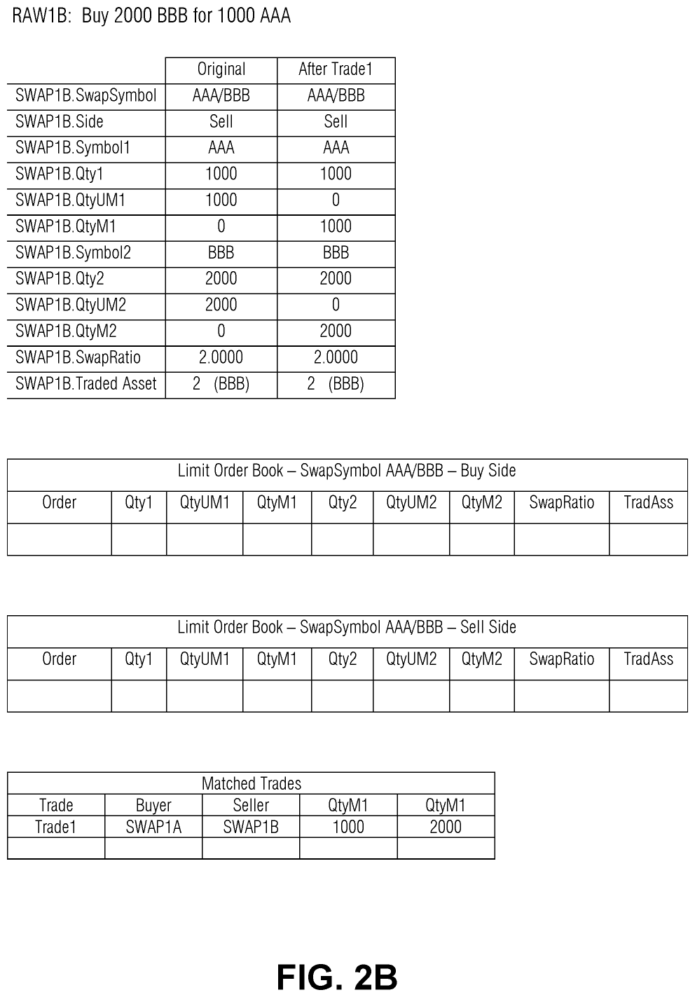

Consider the following Example #1 illustrated in FIG. 2A and FIG. 2B. The NAME book for SwapSymbol AAA/BBB is empty. RAW1A is received: buy 1000 AAA for 2000 BBB. Because RAW1A.Symbol1 is AAA, SWAPA. TradedAsset is set to AAA (RAW1A.Symbol1). The top table in FIG. 2A, shows SWAP1A over its lifetime. At this time, the column headed “Original” reflects SWAP1A as received. The column headed “After Trade 1” shows the state of SWAP1A after Trade1 is matched with SWAPIB which arrives in FIG. 2B. The NAME Normalization Process creates SWAP1A which is placed in the NAME book as shown in FIG. 2A.

Now, RAWIB is received: buy 2000 BBB for 1000 AAA. The NAME Normalization Process will result in creating SWAP1B which is shown in FIG. 2B. Because RAW1B.Symbol1 and RAW1B.Symbol2 are in descending alphanumeric sequence, the NAME Normalization Process will create SWAPIB as a SWAP to sell 1000 AAA for 2000 BBB. SWAP1B.TradedAsset is set to BBB (RAWIB.Symbol).

The NAME matching engine fully matches SWAPIB with SWAP1A. The matched trade is shown at the bottom of FIG. 2B. In FIG. 2A in the column labeled “After Trade 1,” SWAP1A.QtyUM1 is zero. SWAP1A.TradedAsset is AAA. When the unmatched quantity of AAA (SWAP1A.QtyUM1) is zero, SWAP1A is fully matched. Similarly in FIG. 2B in the column labeled “After Trade1,” SWAP1B.TradedAsset is BBB. When the unmatched quantity of BBB (SWAP1B.QtyUM2) is zero, SWAPIB is fully matched.

When a new inbound SWAP (SWAP1B in this case) is being matched against the NAME book (e.g., order resting book 125), it is referred to as SWAPIN to emphasize how the NAME matching engine treats SWAPIN differently than SWAPs already in the NAME book.

Because SWAP1A and SWAPIB have identical values for SwapRatio, there is no price improvement. Therefore, there is no need to adjust either SWAPIN.QtyUM1 or SWAPIN.QtyUM2 other than decrementing each by the quantity matched in Trade1. However, as will be illustrated below, if there were price improvement, it would be SWAPIN.TradedAsset that would determine whether SWAPIN.Symbol1 or SWAPIN.Symbol2 is the DenominatingAsset, which would receive the benefit of any price improvement.

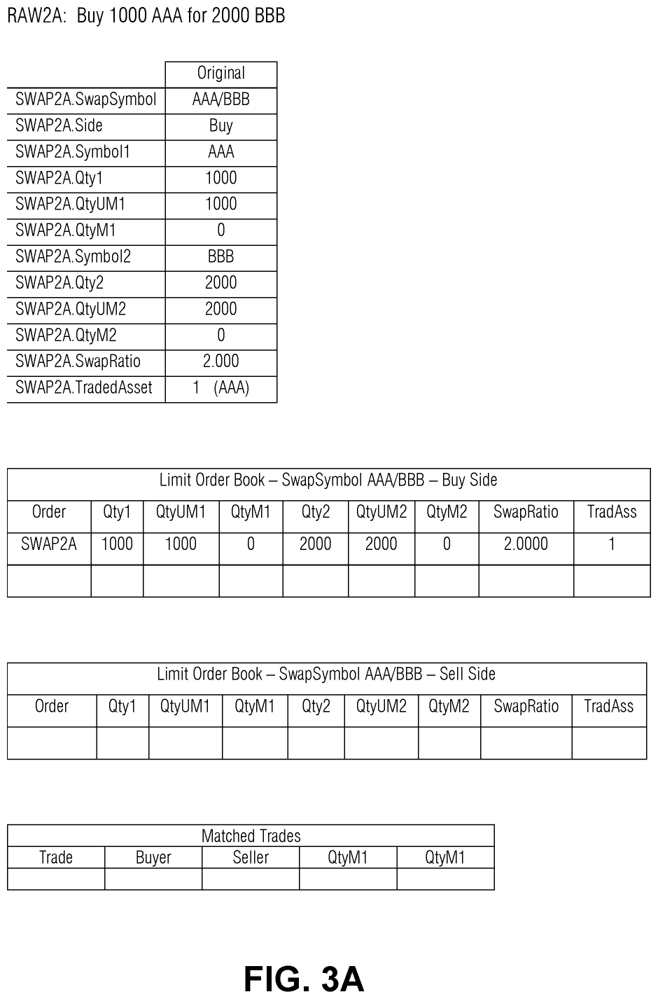

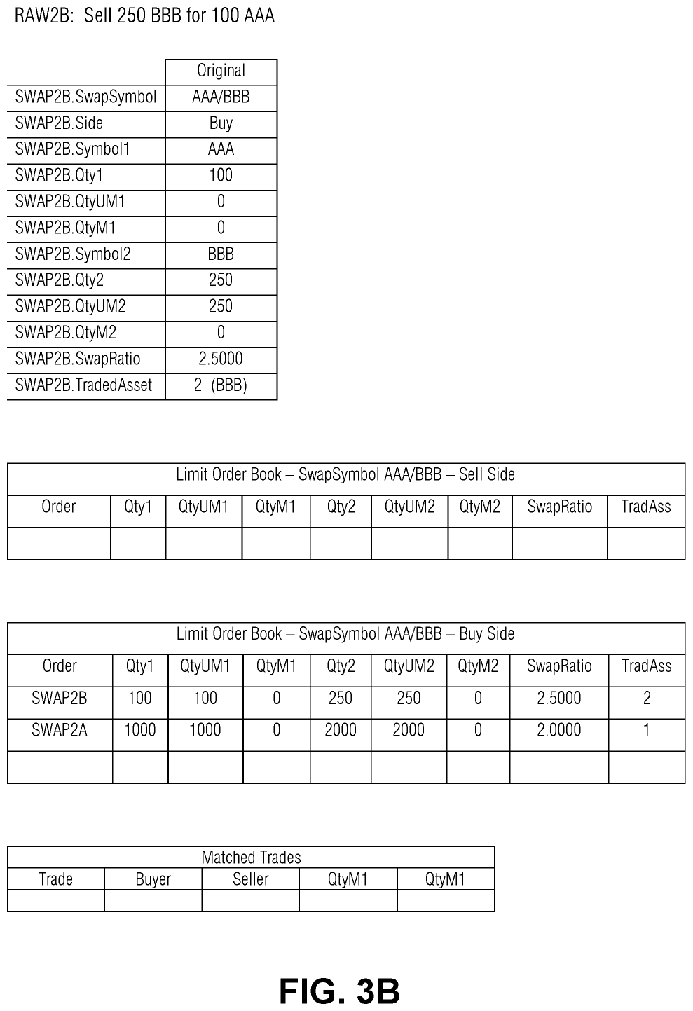

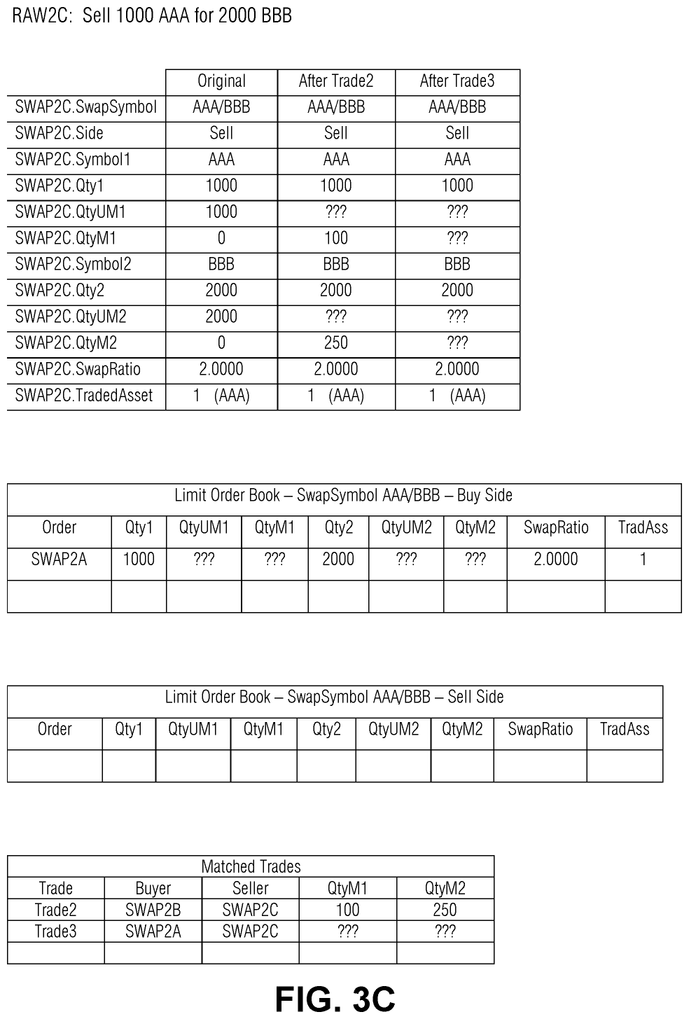

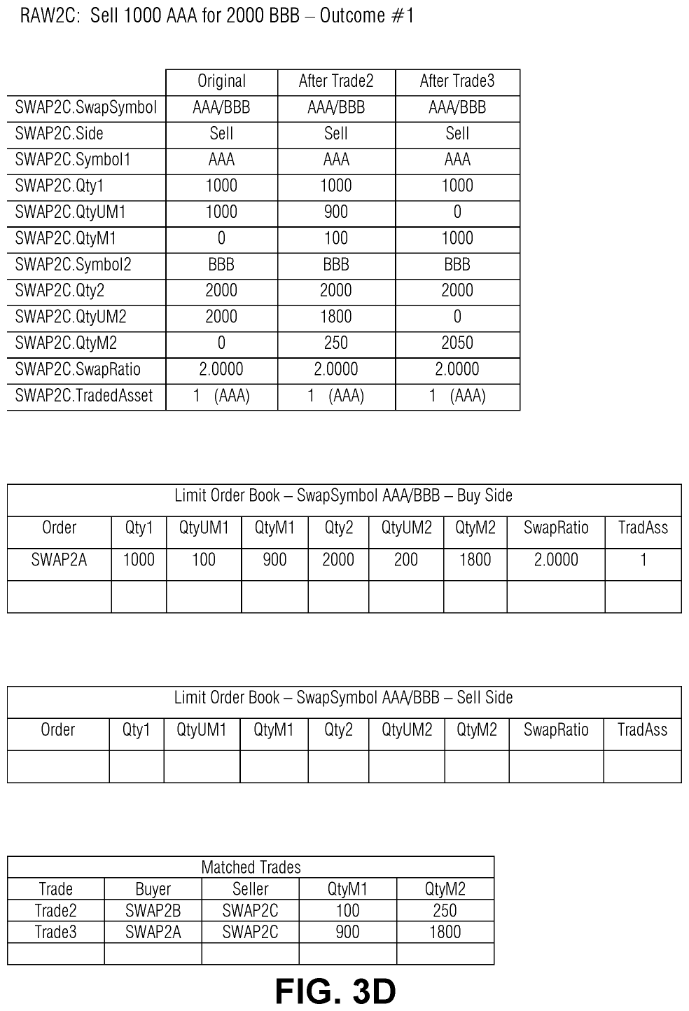

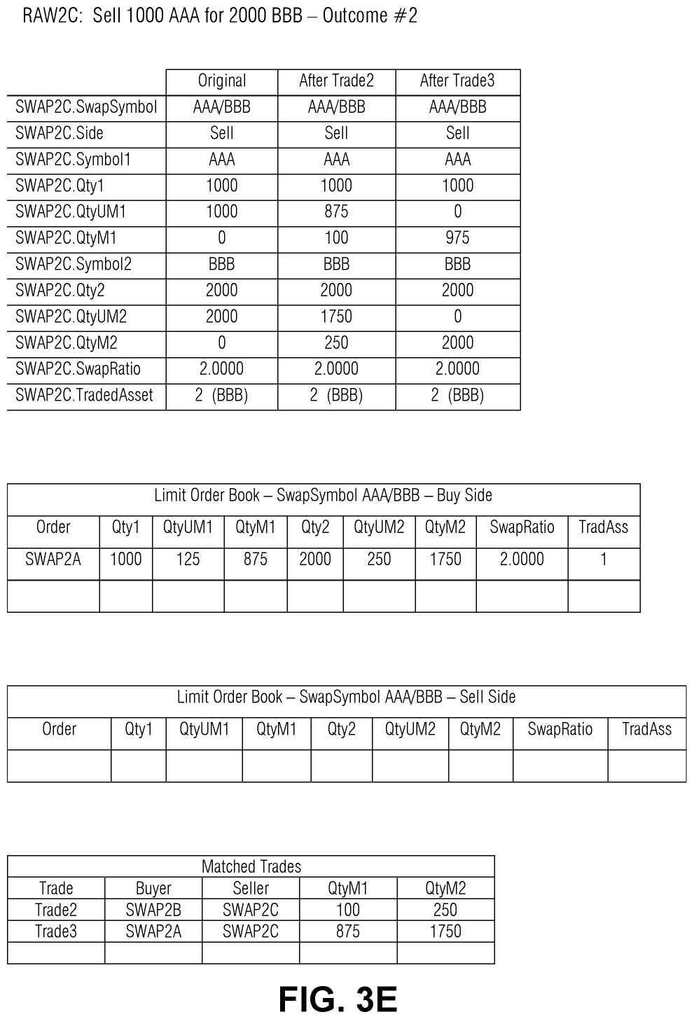

Example #2 demonstrates why SWAPIN.TradedAsset is used to determine the outcome of matching when price improvement occurs. The example, shown in FIG. 3A, begins with an empty AAA/BBB NAME book. Buy RAW2A (buy 1000 AAA for 2000 BBB) arrives, it is converted to SWAP2A, and SWAP2A added to the NAME book as shown in FIG. 3A. RAW2A is identical to RAW1A in FIG. 2A, and it is handled identically.

In FIG. 3B, buy RAW2B (sell 250 BBB for 100 AAA) arrives resulting in SWAP2B which is added to the NAME book. Because RAW2B.Symbol1 and RAW2B.Symbol2 are not in ascending alphanumeric order, normalization converts this to SWAP2B to buy 100 AAA for 250 BBB. SWAP2B.TradedAsset is set to BBB (RAW2B.Symbol1). Because buy SWAP2B has a SwapRatio (2.5) which is greater than buy SWAP2A (2.0), buy SWAP2B is ranked ahead of buy SWAP2A on the buy-side of the NAME book.

In FIG. 3C, buy RAW2C (sell 1000 AAA for 2000 BBB) arrives and is converted to SWAP2C (which is now SWAPIN). Sell SWAPIN has a SwapRatio of 2.00. Buy SWAP2B is the top ranked SWAP on the buy-side of the NAME book. Because SWAP2B.SwapRatio (2.50) is greater than SWAPIN.SwapRatio (2.00), they can be matched, and the match will result in SWAPIN receiving price improvement. Only SWAPIN can receive price improvement because SWAPs in the NAME book always determine the SwapRatio actually matched. Therefore, only SWAPIN can receive price improvement. When SWAPIN is matched with buy SWAP2B, SWAPIN receives 250 BBB in return for delivering 100 AAA. If the quantities matched (100 AAA and 250 BBB) were subtracted from the unmatched quantities on SWAPIN (SWAPIN.QtyUM1 and SWAPIN.QtyUM2), the unmatched quantities remaining on SWAPIN would be 900 AAA and 1750 BBB. These unmatched quantities would imply a SWAPIN.SwapRatio of 1.94444444. This would, however, violate a constraint that the SWAPIN.SwapRatio is equal to the quotient of dividing SWAPIN.QtyUM2 by SWAPIN.QtyUM1. The “???” entries in FIG. 3C ask, what are the correct values of SWAPIN.QtyUM1 by SWAPIN.QtyUM2 after Trade2?

Based on the above, price improvement may lead to different outcomes. The outcomes are based on understanding the intention of the RAW2C sender. That intention is indicated by SWAPIN.TradedAsset, but for the moment, assume that the RAW sender's designation of TradedAsset and DenominatedAsset are unknown.

Outcome #1: assuming that the intention of SWAPIN was to receive at least 2000 BBB in exchange for delivering exactly 1000 AAA with no portion matched at a SwapRatio less than 2.00. When Trade2 (the match between buy SWAP2B and SWAPIN) is made, the actual quantities traded are added to cumulative matched quantities SWAPIN.QtyM1 (100) and SWAPIN.QtyM2 (250). Since the SWAPIN sender wants the completion of the order to be determined when exactly 1000 AAA have been delivered, SWAPIN.QtyUM1 must be decremented by the exact quantity of AAA delivered. However, to keep SWAPIN.QtyUM1 and SWAPIN.QtyUM2 in the proportion of SWAPIN.SwapRatio, SWAPIN.QtyUM2 is decremented by the product of SWAPIN.QtyUM1 times SWAPIN.SwapRatio which is 200 (100 times 2.00) in this example. After these operations, the values of SWAPIN.QtyUM1 and SWAPIN.QtyUM2 are 900 AAA and 1800 BBB. The underscored amount has been adjusted from what actually traded due to price improvement based on the assumption that AAA is the TradedAsset. Therefore, SWAPIN.QtyUM2 is adjusted because the unmatched quantity of AAA (SWAPIN.QtyUM1) is what must be executed exactly. This is because SWAPIN delivered 100 AAA for receiving 250 BBB instead of delivering 125 AAA which would have been expected if there were no price improvement. With Trade3, the balance of SWAPIN is now matched with buy SWAP2A. Both have the same SwapRatio (2.00), so there is no price improvement and no further adjustment. On Trade3, 900 AAA is exchanged for 1800 BBB. As a result of both matches, SWAPIN receives a total of 2050 BBB for a total of 1000 AAA delivered (50 more BBB than SWAPIN was required to receive for delivering 1000 AAA). That difference is price improvement. The entity sending SWAPIN might prefer this Outcome #1 if the party holds exactly 1000 AAA and wants to eliminate that holding completely and acquire more than 2000 BBB if price improvement occurs. FIG. 3D illustrates Outcome #1.

Outcome #2: if the intention of SWAPIN was to receive exactly 2000 BBB in return for delivering no more than 1000 AAA with no portion matched at a SwapRatio less than 2.00, then, to maintain the SwapRatio of 2.0 when matching SWAPIN and buy SWAP2B, SWAPIN.QtyUM2 must be decremented by the exact quantity of BBB received (250). However, to keep SWAPIN.QtyUM1 and SWAPIN.QtyUM2 in the proportion of the SWAPIN.SwapRatio, SWAPIN.QtyUM1 should be decremented by the quotient of SWAPIN.QtyUM2 divided by SWAPIN.SwapRatio which is 125 (250 divided by 2.00). After these actions are taken, the values of SWAPIN.QtyUM1 and SWAPIN.QtyUM2 are 875 AAA and 1750 BBB, respectively. The underscored amount has been adjusted from what actually traded due to price improvement based on the assumption that BBB is the TradedAsset. Therefore, SWAPIN.QtyUM1 is adjusted because the quantity of BBB (SWAPIN.QtyUM2) is what must be executed exactly. This is because SWAPIN received 250 BBB for delivering 100 AAA instead of delivering 125 AAA which would have been expected if there were no price improvement. With Trade3, the balance of SWAPIN is now matched with buy SWAP2A. Both have the same SwapRatio (2.00), so there is no price improvement and no further adjustment. On the second match, 875 AAA is exchanged for 1750 BBB. As a result of both matches, SWAPIN receives a total of 2000 BBB for a total of 975 AAA delivered (25 less AAA than SWAPIN was willing to deliver to receive 1000 AAA). That difference is price improvement. The party sending SWAPIN would prefer this Outcome if the party wanted to receive exactly 2000 BBB and was willing to deliver up to 1000 AAA to acquire 2000 BBB. FIG. 3D illustrates Outcome #1.

Outcome #1 and Outcome #2 indicate that, with a RAW object specifying only two asset symbols, the quantities of each asset to swap, which asset will be received, and which will be delivered may lead to very different results regarding how a matching engine is configured when some portion of the resulting SWAPIN is matched with price improvement.

A traditional matching engine—in which there is only one resting order book for all swap orders for a given pair of assets—has no information from the swap order regarding which outcome (e.g., Outcome #1 or Outcome #2 above) is chosen. Therefore, the trading center selects one outcome to apply to all swap orders. This limits the RAW sender's choices, preventing the entity 130 from selecting an outcome. An alternative is operating two resting order books for each pair of assets (AAA/BBB and BBB/AAA) which is undesirable due to the inherent market inefficiency it introduces.

To address this ambiguity, the entity 130 selects the outcome by enabling the identification of the traded asset or the denominating asset. For example, RAW.Symbol1 may be defined as the TradedAsset, which determines when the associated SWAP is completely matched. If SWAPIN.TradedAsset (RAW.Symbol1) is AAA, then the NAME matching engine will produce Outcome #1 to this SWAPIN. If SWAPIN.TradedAsset (RAW.Symbol1) is BBB, then the NAME matching engine will produce Outcome #2 to this SWAPIN.

By changing RAW2C from (Case #1: sell 1000 AAA for 2000 BBB) to (Case #2: buy 2000 BBB for 1000 AAA) the only difference in the resulting SWAP2C is that RAW2C. TradedAsset is changed from AAA to BBB.

If RAW2C is submitted as (sell 1000 AAA for 2000 BBB), then SWAP2C. TradedAsset would be set to AAA (RAW2C.Symbol1). Outcome #1 would be the result. SWAP2C would deliver 1000 AAA and receive 2050 BBB and with 50 BBB received as price improvement.

If RAW2C is submitted as (sell 2000 BBB for 1000 AAA), SWAP2C. TradedAsset would be set to BBB (RAW2C.Symbol1). Outcome #2 would be the result. SWAP2C would deliver 975 AAA and receive 2000 BBB with 25 AAA retained as price improvement.

As shown in Example #2, the third task, by setting SWAP.TradedAsset to RAW.Symbol1, the swap order sender has control over whether Outcome #1 or Outcome #2 will take place if price improvement occurs in a matching engine which manages all swap orders for the same two assets to be processed in a single NAME book.

In summary, an inbound unnormalized swap order (RAW) is normalized as described above to maximize the flexibility of the RAW sender (e.g., entity 130 or 135) to direct how to match RAW if price improvement occurs by selecting TradedAsset. This enables all swap orders for each pair of assets to be managed in a single NAME book. SWAPIN may then be managed with SWAPs in the NAME book consistent with the TradedAsset selected by the RAW sender. Any unexecuted portion of SWAPIN is stored in the NAME book (if appropriate) as intended by the RAW sender. In an example, any unexecuted portions of SWAPIN and its associated RAW are canceled.

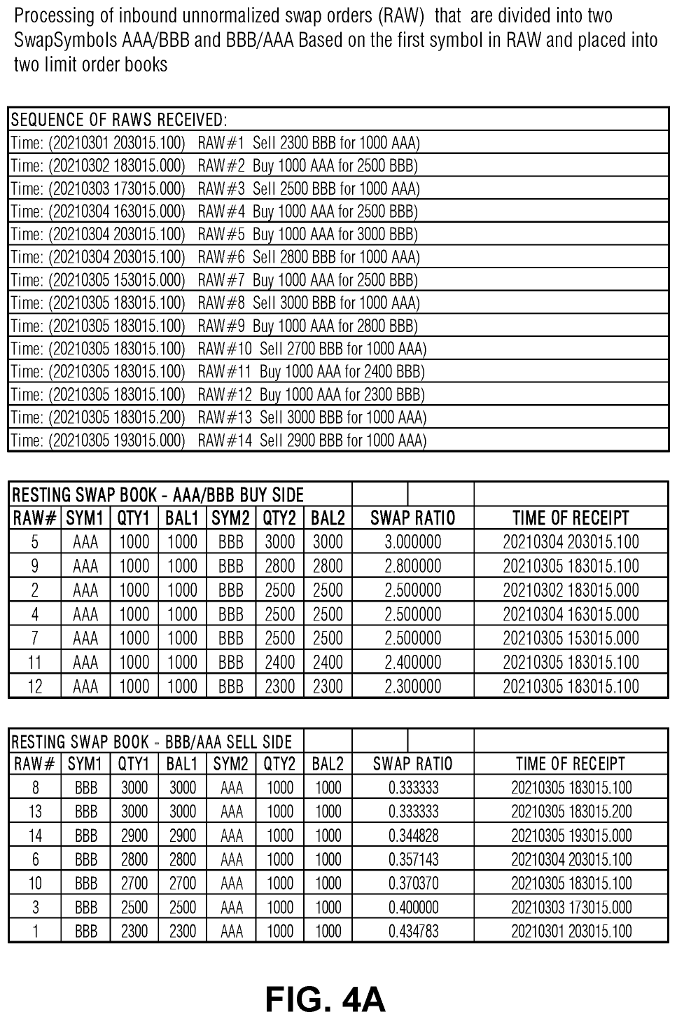

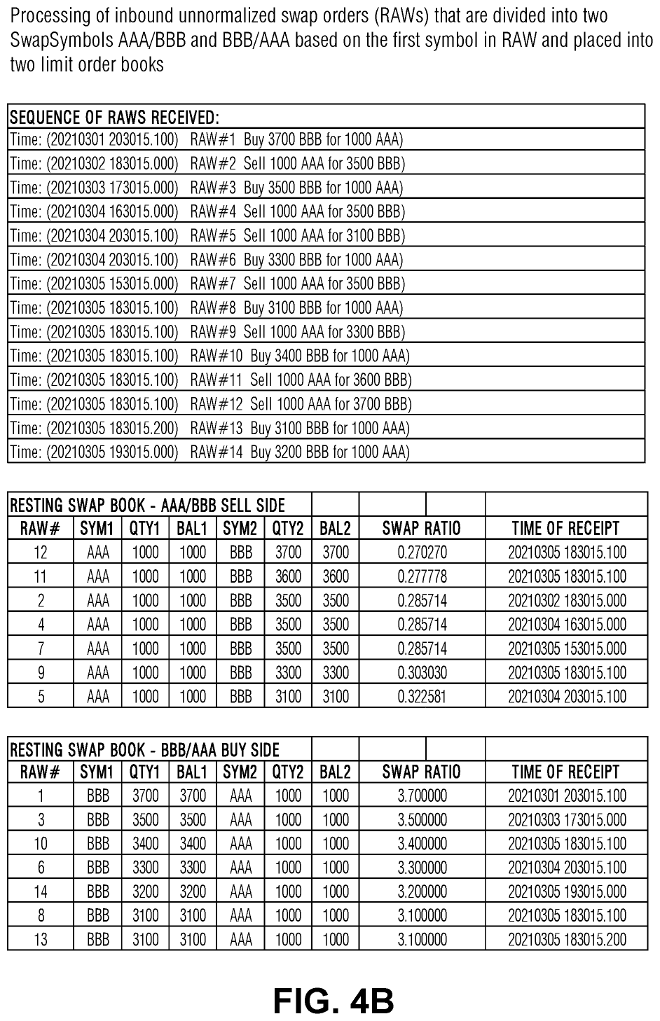

FIG. 4A and FIG. 4B depict a sequence of unnormalized swap orders (RAWs) to swap assets AAA and BBB. A traditional matching engine is likely to divide these swap orders into two groups: one set for SwapPair(AAA,BBB) and another set for SwapPair (BBB,AAA).

FIG. 4A shows a sequence of unnormalized swap orders (RAWs) to exchange assets AAA and BBB. The traditional matching engine shown defines a SwapPair(Symbol1,Symbol2) with a SwapSymbol of Symbol1/Symbol2 appearing in the same sequence that they appear on the associated RAW. In this traditional matching engine RAW.Qty1 (for RAW.Symbol1) is the default used to determine when the matching engine matching of RAW is complete. These RAWs are sent to one of two resting order books. Each RAW is sent to the resting order book which manages its SwapSymbol. RAW.Side is not changed. These particular RAWs were chosen to illustrate that they are divided between the buy-side of the AAA/BBB resting order book and the sell-side of the BBB/AAA resting order book.

FIG. 4B shows a sequence of unnormalized swap orders (RAWs) to exchange assets AAA and BBB. The same traditional matching engine shown in FIG. 4A is employed. FIG. 4B, like FIG. 4A, includes RAWs to exchange assets AAA and BBB. These RAWs are sent to one of two resting order books. Each RAW is sent to the resting order book which manages its SwapSymbol. RAW.Side is not changed. These particular RAWs were chosen to illustrate that they are divided between the sell-side of the AAA/BBB resting order book and the buy-side of the BBB/AAA resting order book.

When this traditional matching engine adds the unexecuted portion of a new RAW into the resting order book, the RAW is placed into the appropriate side of the resting order book at a location which preserves SwapRatio-Time priority ranking.

The following are various examples of component objects that may be contained within a RAW object:
SII—Source Identifying Information to identify the source of a message.
TimeOfReceipt—time when the NAME matching engine receives the RAW from the inbound message queue
Side (B to buy Symbol1, S to sell Symbol1)
Symbol1
Qty1—this determines when the RAW is fully matched.
Symbol2
Qty2—the minimum or maximum quantity of Symbol2 to be exchanged for Qty1 of Symbol1
TimeInForce—A Order Modifier which determines the longevity of a RAW or SWAP. Typical values are:
   GTC—Good until cancelled.
   DAY—Good until a certain time is next reached. For example, DAY may be set to cancel all DAY SWAPs at 5:00 AM which may, in fact, be on the following day.
   IOC—Immediate or Cancel. Any unmatched portion of an IOC SWAP which cannot be matched as an inbound SWAP will be automatically cancelled by the Matching Engine rather than being placed in the NAME book.
   FOK—Fill or Kill. A FOK SWAP is either fully matched as an inbound SWAP, or no portion of it is matched and the entire SWAP is cancelled the Matching Engine rather than being placed in the NAME book.
   An implementation of NAME may set a default value if TimeInForce is not included in a RAW.
MinQty—the minimum quantity of Symbol1 must be matched on initial receipt and matching of the SWAP created from this RAW. If MinQty or more of that Symbol1 cannot be matched, then the SWAP and the associated RAW are cancelled.
MTP—Matched trade prevention instructions which assure that the same principle is not on both sides of the same matched trade.
PostOnly—(an order modifier) The SWAP and the associated RAW will be rejected if it would immediately match with any resting order rather than be placed in the NAME limit order book.
Other order Modifiers and data that are used to submit swap orders to traditional matching engines.

Traditional matching engines may have a default TradedAsset value to determine whether a swap order has been completely matched. In contrast, the present techniques determine which symbol is the governing symbol during swap order normalization based on, for example, the content of the SWAP object as controlled by the entity sending the RAW object.

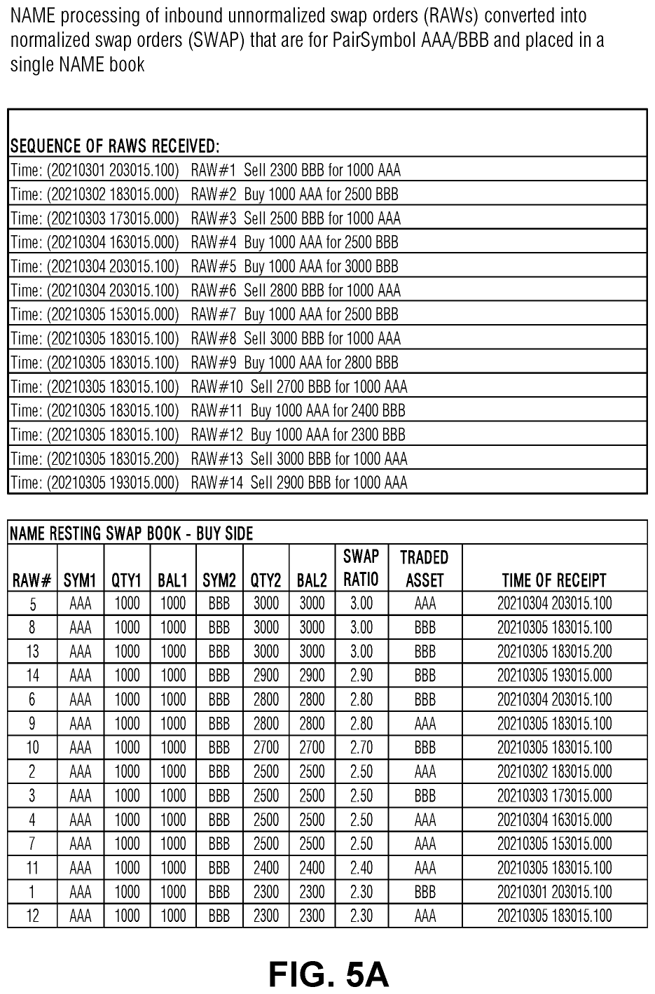

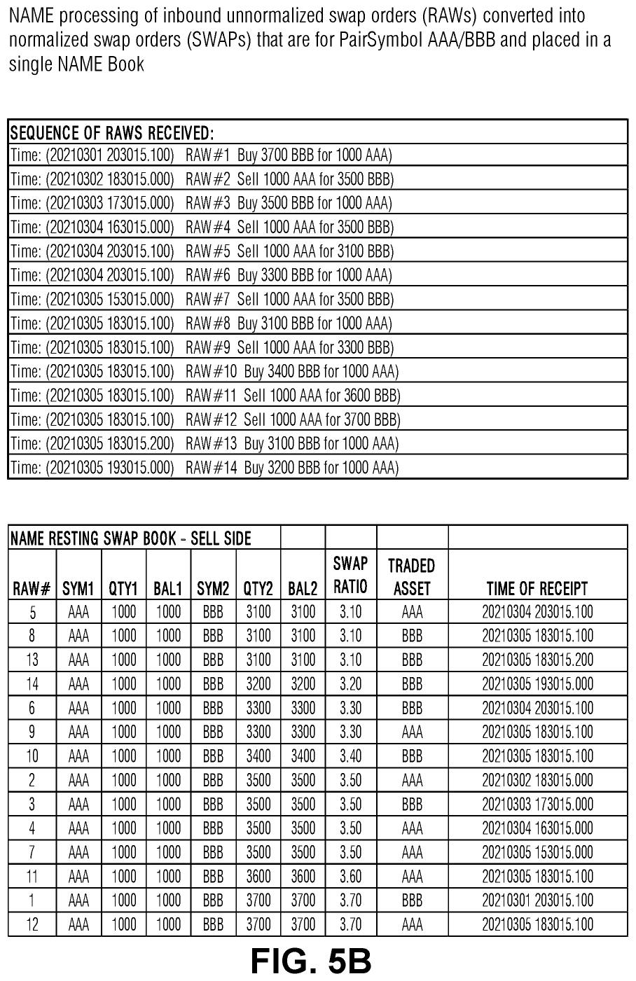

FIG. 5A shows the same sequence of arriving RAWs as shown in FIG. 4A. The NAME Normalization Process is applied to each RAW to create an associated SWAP. Unlike FIG. 4A, all of the SWAPs are placed into the buy-side of the NAME book for one SwapSymbol—AAA/BBB—because each seeks to receive (buy) AAA and deliver (sell) BBB. This is true whether the RAW arrives in the (Form #1: buy <qty>AAA for <qty>BBB) or (Form #2: sell <qty>BBB for <qty>AAA). FIG. 5A demonstrates how NAME eliminates the inefficiency of maintaining two resting order books for the same pair of asset Symbols. Each of the 14 SWAPs in FIG. 5A is added to the buy-side of the NAME book instead of being divided between two resting order books as in FIG. 4A. SWAP.TradedAsset is shown for each SWAP. The NAME book is ranked using SwapRatio-Time priority.

FIG. 5B shows the same sequence of arriving RAWs as shown in FIG. 4B. The NAME Normalization Process is applied to each RAW to create an associated SWAP. Unlike FIG. 4B, all of the SWAPs are placed into the sell-side of the NAME book for one SwapSymbol—AAA/BBB—because each seeks to deliver (sell) AAA and receive (buy) BBB. This is true whether the RAW arrives in the (Form #1: buy <qty>BBB for <qty>AAA) or (Form #2: sell <qty>AAA for <qty>BBB). Like FIG. 5A, FIG. 5B demonstrates how NAME eliminates the inefficiency of maintaining two resting order books for the same pair of asset Symbols. Here, each of the 14 SWAPs in FIG. 5B is added to the sell-side of the NAME book instead of being divided between two resting order books as in FIG. 4B. SWAP.TradedAsset is shown for each SWAP. The NAME book is ranked using SwapRatio-Time priority.

The following illustrates example components of a SWAP (e.g., normalized swap order) object:
SII—Source Identifying Information to identify the source of a message
TimeOfReceipt—time when the RAW from the inbound message queue
SwapSymbol—of the form Symbol1/Symbol2 where Symbol1<Symbol2. If these two symbols need to be reversed, corresponding changes are made to Qty1, Qty2, and Side
Side (B to buy Symbol1, S to sell Symbol1)
Symbol1
Qty1—the quantity of Symbol1 to be exchanged for Qty2 of Symbol2 which must be met to match with this SWAP with another SWAP
QtyM1—the unmatched quantity of Symbol1—is initialized to zero
QtyUM1—the unmatched quantity of Symbol1—is initialized to Qty1
Symbol2
Qty2—the quantity of Symbol2 to be exchanged for Qty1 of Symbol1 which must be met to match with this SWAP with another SWAP
QtyM2—the unmatched quantity of Symbol2—is initialized to zero
QtyUM2—the unmatched quantity of Symbol2—is initialized to Qty2
SwapRatio is set to Qty2/Qty1.
TradedAsset is set to RAW.Symbol1. TradedAsset determines whether SWAP.QtyUM1 or SWAP.QtyUM2 determines when SWAP is completely matched.
TimeInForce—GTC (default), DAY, IOC, or FOK
MinQty—the minimum quantity of TradedAsset which must be matched on initial receipt and matching of the SWAP. If MinQty or more of the TradedAsset cannot be matched on initial receipt and matching, then SWAP and its associated RAW are cancelled with no matches being made. Default value is zero.
MTP—Matched Trade Prevention assures that the same principle is not on both sides of the same matched trade—I, R, B. If none is provided, default is that MTP is disabled.
PostOnly—The SWAP will be rejected if it would immediately match with any resting SWAP in the NAME Book with no match made.
Other order Modifiers and data that is used to submit swap orders to traditional matching engines.

SWAP objects which are created by applying the NAME Normalization Process to a RAW object. SWAP.SwapSymbol is set to be the concatenation of SWAP.Symbol1, a slash character, and SWAP.SwapSymbol2 in ascending alphanumeric order with no spaces separating them. Thus, each SWAP which seeks to swap assets AAA and BBB must have a SWAP.SwapSymbol of AAA/BBB regardless of the sequence in which the Symbols AAA and BBB appear in the associated RAW and regardless of which is asset is being acquired or delivered.

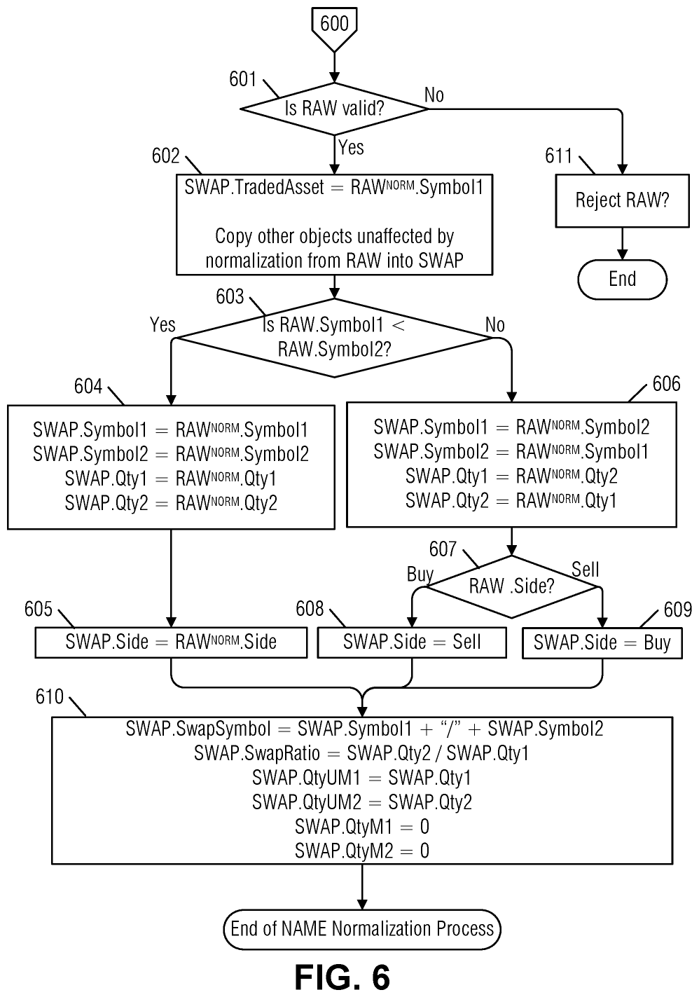

As illustrated in FIG. 6, the handling of a new RAW object begins at operation 600. Handling of the inbound message queue and handling of messages other than a new RAW operate as in traditional systems (e.g., traditional matching engines). Processing continues at operation 601.

At operation 601, if the RAW object is valid, processing continues at operation 602. Otherwise, processing continues at operation 611. In an example, if the symbols are the same (e.g., RAW.Symbol1 is equal to RAW.Symbol2), then the RAW object is not valid.

At operation 602, the conversion of the RAW object into a SWAP object begins by setting SWAP.TradedAsset to RAW.Symbol1. This controls allocation of any price improvements when SWAP is being matched as an inbound order. Next, various other values which are not changed by the normalization are copied from the RAW object into the SWAP object. Examples of such objects are RAW order modifiers including SII, TimeOfReceipt, TimeInForce, MTP, MinQty, and PostOnly. Processing continues at operation 603.

At operation 603, RAW.Symbol1 and RAW.Symbol2 are compared. In an example, symbols are not equal (under an ordering regime) in a valid RAW object (e.g., operation 601. If the symbols are not in ascending alphanumeric sequence, then their positions are changed as part of normalization to ensure that that SWAP.Symbol1 and SWAPIN.Symbol2 are in ascending alphanumeric sequence. If the symbols are already in ascending alphanumeric sequence, processing continues at operation 604. Otherwise, processing continues at operation 606.

At operation 604, RAW.Symbol1 and RAW.Symbo2 are already in ascending alphanumeric sequence. Symbol1, Symbol2, Qty1, Qty2, and Side are copied from the RAW object into the SWAP object. Processing continues at operation 605.

At operation 605, the Side field (e.g., member) is copied from the RAW object into the SWAP object. The Side field does not change during normalization in this case because the positions of Symbol1 and Symbol2 were not switched. Processing continues at operation 610.

At operation 606, it has been determined that RAW.Symbol1 and RAW.Symbol2 are in descending alphanumeric sequence. As part of the normalization, the positions of Symbol1 and Symbol2 are reversed by setting SWAP.Symbol1 to RAW.Symbol2 (e.g., SWAP.Symbol1:=RAW.Symbol2) and setting SWAP.Symbol2 to RAW.Symbol1. This assures that SWAP. Symbol1 and SWAP.Symbol2 are in ascending alphanumeric sequence. The quantity of each asset to be exchange is moved to ensure correspondence with the previous symbol positions. Thus, SWAP.Qty2 is set to RAW.Qty1 and SWAP.Qty1 is set to RAW.Qty2. This ensures that the correct total order Qty is aligned with the appropriate Symbol. Processing continues at operation 607.

At operation 607, RAW.Side is also changed to correspond to the new position of the symbols (e.g., Symbol1 and Symbol2). If RAW.Side is buy, processing continues at operation 608. Otherwise, processing continues at operation 609.

At operation 608, SWAP.Side is changed to sell to reverse from RAW.Side which is buy. Processing continues at operation 610.

At operation 609, SWAP.Side is changed to buy to reverse from RAW.Side which is sell Processing continues at operation 610.

At operation 610, SWAP.Symbol1 and SWAP.Symbol2 are in ascending alphanumeric sequence. In an example, SWAP.SwapSymbol is set to the concatenation of SWAP.Symbol1, a slash character (“/”), and SWAP.Symbol2. SWAP.SwapRatio is calculated as SWAP.Qty2 divided by SWAP.Qty1. For each symbol, the unmatched quantity is set to the total quantity. For example, SWAP.QtyUM1 is set to SWAP.Qty1 and SWAP.QtyUM2 is set to SWAP.Qty2. For each symbol, the matched quantity—e.g., SWAP.QtyM1 or SWAP.QtyM2—is set to zero. At this stage, normalization is complete. In an example, processing returns to the first matching pass.

After normalization is complete, one or two matching passes may be performed. In an example, while the NAME matching engine is processing an inbound SWAP object, the new inbound SWAP object will be called SWAPIN to distinguish it from any SWAP which is resting in the NAME book.

The first matching pass does not change the inbound order, any orders in the resting order book, or the state of the resting order book. The first matching pass simulates what would take place in a second matching pass where SWAP object matching and other actions could change SWAPIN, one or more SWAPs in the NAME book, or the state of the NAME book.

During the simulated matching pass, the matching engine compares SWAPIN to resting SWAPs on the contra side of the NAME book in the sequence that the NAME book has ranked them. No actual matching occurs during the first pass. Neither SWAPIN nor the NAME book is modified. If the matching engine determines that no additional simulated matching of SWAPIN can take place, the simulated matching pass ends, and a determination of how to proceed is made.

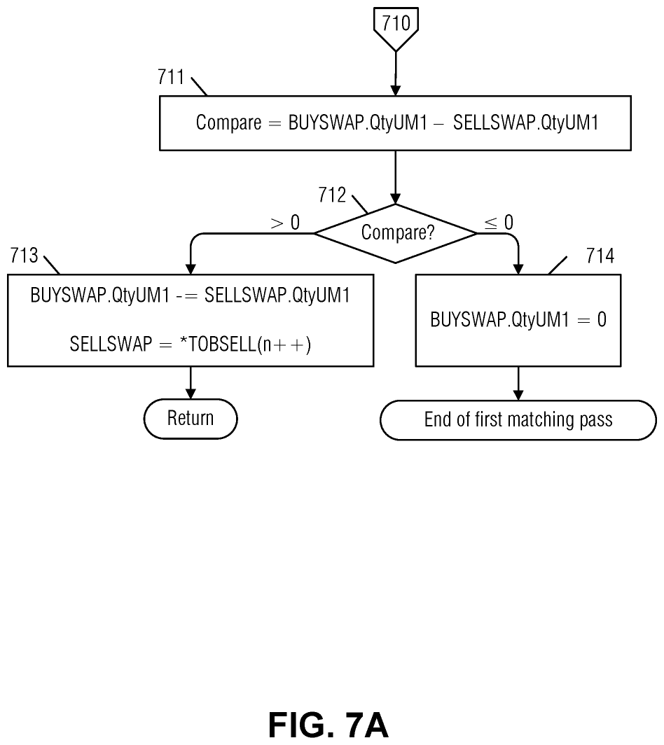

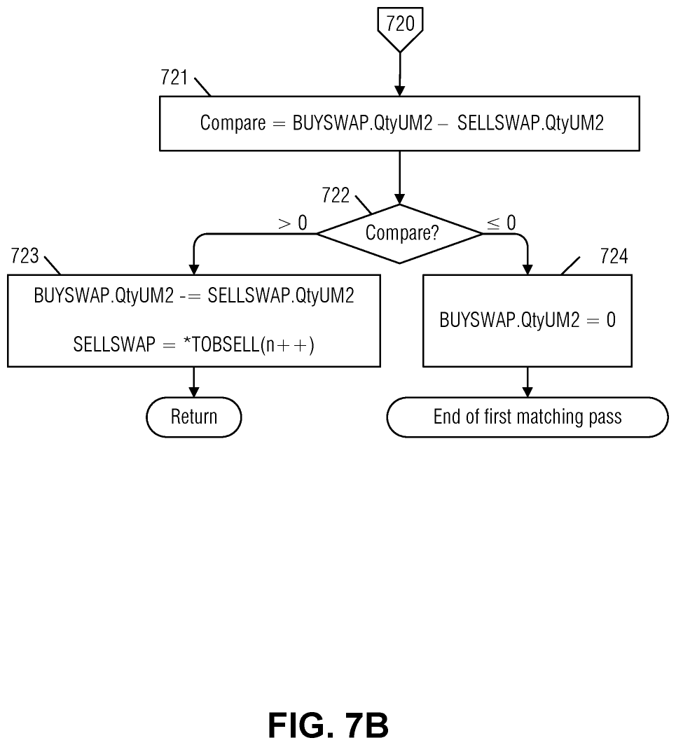

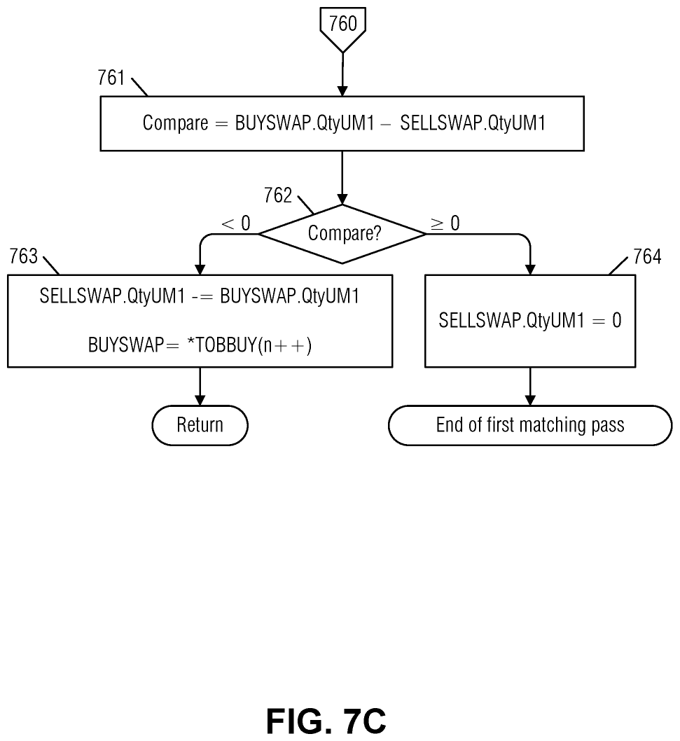

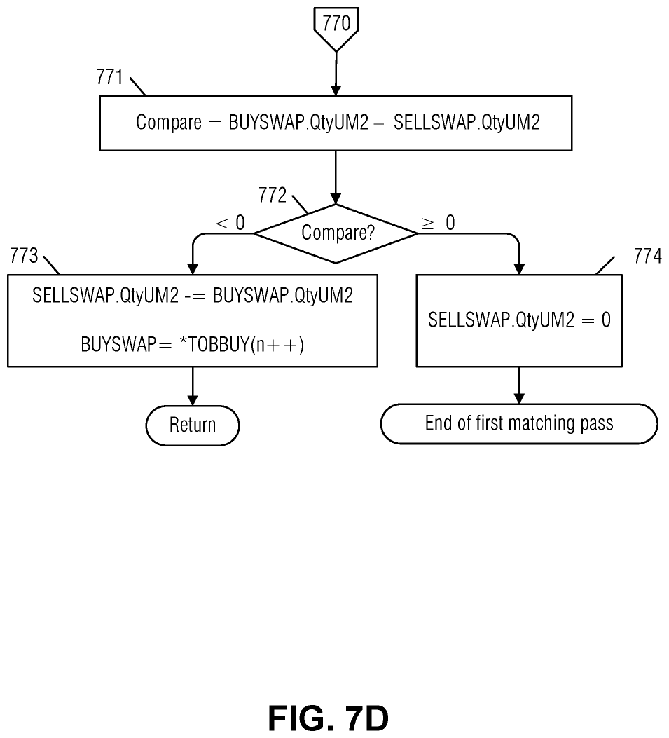

FIG. 7A, FIG. 7B, FIG. 7C, and FIG. 7D illustrate examples of a first matching pass where an inbound swap order is simulated to determine whether to proceed to a second matching pass, according to an embodiment. This first pass determines the extent to which SWAPIN would complete matches in the second matching pass. If the first pass determines that (i) SWAPIN will not match with any SWAP object in the NAME book, (ii) applying the MTP Protocol will not result in cancelling any SWAP object resting in the NAME book, or (iii) applying the MTP Protocol will not result in cancelling SWAPIN.

There are the four possible situations when a match can be made. The purpose of the simulated matching is to determine how far into the actual matching process SWAPIN would proceed and what actions would take place during the actual matching process up to that point. Therefore, the simulated matching process ends when (i) the quantity of SWAPIN to be matched has been completed, or (ii) no other matching of SWAPIN is possible. Where NAME looks for SWAPIN in the NAME book to match is dependent on SWAPIN.Side. The quantity of SWAPIN to be matched is dependent on the SwapRatio of the resting SWAP in the NAME book. Table 1 illustrates an example of managing the four combinations of SWAPIN. Side and SWAPIN.TradedAsset that may arise.

TABLE 1

| | SWAPIN.TradedAsset = | SWAPIN.TradedAsset = |
|---|---|---|
| | Symbol1 | Symbol2 |
| SWAPIN.Side = | FIG. 7A | FIG. 7B |
| buy | | |
| SWAPIN.Side = | FIG. 7C | FIG. 7D |
| sell | | |

In all four figures, objects which are copies of SWAP have been created to avoid altering SWAPIN or the SWAP resting in the NAME book to which a match is currently being simulated.

Two functions may be used in the operation of the first or second matching passes: TOPBUY(n) and TOPSELL(n). TOPBUY(n) returns a pointer to the nth highest ranked SWAP on the buy-side of the NAME book. TOPSELL(n) returns a pointer to the nth highest ranked SWAP on the sell-side of the NAME book.

In the first matching pass, prior to entering into 710 in FIG. 7A or 720 in FIG. 7D, BUYSWAP is set to equal the inbound SWAPIN, so that modifying BUYSWAP will not affect SWAPIN, which may be matched during the second pass. TOBSELL(0) is called to set SELLSWAP to the highest ranked sell-SWAP resting in the NAME book or NULL if there is none. The function TOBSELL(n++) is used in the first matching pass to locate the next highest ranked SWAP in the NAME book or NULL if there is none without altering the NAME book.

In the second matching pass, TOBSELL(0) is called to set SELLSWAP to the highest ranked sell-SWAP resting in the NAME book or NULL if there is none. Since fully matched sell-SWAPs are removed from the NAME book, subsequent matching iterations call TOBSELL(0) to identify the new highest ranked sell-SWAP resting in the NAME book or NULL if there is none.

In the first matching pass, prior to entering into 760 in FIG. 7C or 770 in FIG. 7B, SELLSWAP is set to equal the inbound SWAPIN so that modifying SELLSWAP will not affect SWAPIN, which may be matched during the second pass. TOBBUY(0) is called to set BUYSWAP to the highest ranked buy-SWAP resting in the NAME book or NULL if there is none. The function TOBBUY(n++) is used in the first pass to locate the next highest ranked SWAP in the NAME book or NULL if there is none. This leaves the NAME book unaltered.

In the second matching pass, TOBBUY(0) is called to set BUYSWAP to the highest ranked buy-SWAP resting in the NAME book or NULL if there is none. Since fully matched buy-SWAPs are removed from the NAME book, subsequent matching iterations call TOBBUY(0) to identify the new highest ranked buy-SWAP resting in the NAME book or NULL if there is none.

At operation 710 in FIG. 7A, BUYSWAP is a copy of the inbound SWAPIN at this stage of simulated matching which reflects any prior simulated matches, and SELLSWAP is a copy of the highest ranked sell-SWAP resting in the NAME book at this step of simulated matching. BUYSWAP.QtyUM1 is used to determine when execution of BUYSWAP is complete because BUYSWAP.TradedAsset equals BUYSWAP.Symbol1. Processing continues at operation 711.

At operation 711, it has already been determined that BUYSWAP will be matched with SELLSWAP. The unmatched quantities of BUYSWAP and SELLSWAP are compared. The smaller quantity dictates the quantity to be matched. Processing continues at operation 712.

At operation 712, If compare is greater than zero, then the quantity to match is SELLSWAP.QtyUM1, and processing continues at operation 712. Otherwise, the quantity to match is BUYSWAP.QtyUM1, and processing continues at operation 713.

At operation 713, the simulated match of SELLSWAP.QtyUM1 of SELLSWAP.Symbol1 occurs. BUYSWAP.QtyUM1 is decremented by SELLSWAP.QtyUM1. Because this is just a simulation, only BUYSWAP.QtyUM1 needs to be calculated, since that is the available quantity left to be matched. SELLSWAP is now fully matched. SELLSWAP is now set to the contents of *TOBSELL(n++) which returns the next highest ranked SWAP on the sell-side of the NAME book or a NULL value if there are no additional SWAPs on the sell-side of the NAME book. BUYSWAP and SELLSWAP are evaluated to determine whether they can be matched. If so, 710 will be reentered to simulate that match.

At operation 714, the SELLSWAP.QtyUM1 is sufficient to complete matching of BUYSWAP. Therefore, BUYSWAP.QtyUM1 is set to zero, and no additional matches of BUYSWAP are possible. The first matching pass is complete, and processing returns to the location in a traditional matching engine where a determination is made on whether to cancel SWAPIN, proceed to the second matching pass, or bypass the second matching pass and proceed to processing which would otherwise occur at the end of the second matching process.

At operation 720 in FIG. 7B, BUYSWAP is a copy of the inbound SWAPIN at this stage of simulated matching which reflects any prior simulated matches, and SELLSWAP is a copy of the highest ranked sell-SWAP resting in the NAME book at this step of simulated matching. BUYSWAP.QtyUM2 is used to determine when execution of BUYSWAP is complete because BUYSWAP.TradedAsset equals BUYSWAP.Symbol2. Processing continues at operation 721.

At operation 721, it has already been determined that BUYSWAP will be matched with SELLSWAP. The unmatched quantities of BUYSWAP and SELLSWAP are compared. The smaller quantity dictates the quantity to be matched. Processing continues at operation 722.

At operation 722, If compare is greater than zero, then the quantity to match is SELLSWAP.QtyUM2, and processing continues at operation 722. Otherwise, the quantity to match is BUYSWAP.QtyUM2, and processing continues at operation 723.

At operation 723, the simulated match of SELLSWAP.QtyUM2 of SELLSWAP.Symbol2 occurs. BUYSWAP.QtyUM2 is decremented by SELLSWAP.QtyUM2. Because this is just a simulation, only BUYSWAP.QtyUM2 needs to be calculated, since that is the available quantity left to be matched. SELLSWAP is now fully matched. SELLSWAP is now set to the contents of *TOBSELL(n++) which returns the next highest ranked SWAP on the sell-side of the NAME book or a NULL value if there are no additional SWAPs on the sell-side of the NAME book. BUYSWAP and SELLSWAP are evaluated to determine whether they can be matched. If so, 720 will be reentered to simulate that match.

At operation 724, the SELLSWAP.QtyUM2 is sufficient to complete matching of BUYSWAP. Therefore, BUYSWAP.QtyUM2 is set to zero, and no additional matches of BUYSWAP are possible. The first matching pass is complete, and a determination is made whether to cancel SWAPIN, proceed to the second matching pass, or bypass the second matching pass.

At operation 760 in FIG. 7C, BUYSWAP is a copy of the highest ranked buy-SWAP resting in the NAME book at this step of simulated matching and SELLSWAP is a copy of the inbound SWAPIN at this stage of simulated matching, which reflects any prior simulated matches. SELLSWAP.QtyUM1 is used to determine when execution of SELLSWAP is complete because SELLSWAP.TradedAsset equals SELLSWAP.Symbol1. Processing continues at operation 761.

At operation 761, it has already been determined that BUYSWAP will be matched with SELLSWAP. The unmatched quantities of BUYSWAP and SELLSWAP are compared. The smaller quantity dictates the quantity to be matched. Processing continues at operation 762.

At operation 762, If compare is less than zero, then the quantity to match is BUYSWAP.QtyUM1, and processing continues at operation 762. Otherwise, the quantity to match is SELLSWAP.QtyUM1, and processing continues at operation 763.

At operation 763, the simulated match of BUYSWAP.QtyUM1 of SELLSWAP.Symbol1 occurs. SELLSWAP.QtyUM1 is decremented by BUYSWAP.QtyUM1. Because this is just a simulation, only SELLSWAP.QtyUM1 may be calculated since that is the available quantity left to be matched. BUYSWAP is now fully matched. BUYSWAP is now set to the contents of *TOBBUY(n++) which returns the next highest ranked SWAP on the buy-side of the NAME book or a NULL value if there are no additional SWAPs on the buy-side of the NAME book. BUYSWAP and SELLSWAP are evaluated to determine whether they can be matched. If so, 760 will be reentered to simulate that match.

At operation 764, the BUYSWAP.QtyUM1 is sufficient to complete matching of SELLSWAP. Therefore, SELLSWAP.QtyUM1 is set to zero, and no additional matches of BUYSWAP are possible. The first matching pass is complete, and a determination is made on whether to cancel SWAPIN, proceed to the second matching pass, or bypass the second matching pass.

At operation 770 in FIG. 7D, BUYSWAP is a copy of the highest ranked buy-SWAP resting in the NAME book at this step of simulated matching, and SELLSWAP is a copy of the inbound SWAPIN at this stage of simulated matching which reflects any prior simulated matches. SELLSWAP.QtyUM2 is used to determine when execution of SELLSWAP is complete because SELLSWAP.TradedAsset equals SELLSWAP.Symbol2. Processing continues at operation 771.

At operation 771, it has already been determined that BUYSWAP will be matched with SELLSWAP. The unmatched quantities of BUYSWAP and SELLSWAP are compared. The smaller quantity dictates the quantity to be matched. Processing continues at operation 772.

At operation 772, If compare is less than zero, then the quantity to match is BUYSWAP.QtyUM1, and processing continues at operation 772. Otherwise, the quantity to match is SELLSWAP.QtyUM1, and processing continues at operation 773.

At operation 773, the simulated match of BUYSWAP.QtyUM2 of SELLSWAP.Symbol2 occurs. SELLSWAP.QtyUM2 is decremented by BUYSWAP.QtyUM2. Because this is just a simulation, only SELLSWAP.QtyUM2 may be calculated since that is the available quantity left to be matched. BUYSWAP is now fully matched. BUYSWAP is now set to the contents of *TOBBUY(n++) which returns the next highest ranked SWAP on the buy-side of the NAME book or a NULL value if there are no additional SWAPs on the buy-side of the NAME book. BUYSWAP and SELLSWAP are evaluated to determine whether they can be matched. If so, 770 will be reentered to simulate that match.

At operation 774, the BUYSWAP.QtyUM1 is sufficient to complete matching of SELLSWAP. Therefore, SELLSWAP.QtyUM1 is set to zero, and no additional matches of BUYSWAP are possible. The first matching pass is complete, and a determination is made on whether to cancel SWAPIN, proceed to the second matching pass, or bypass the second matching pass.

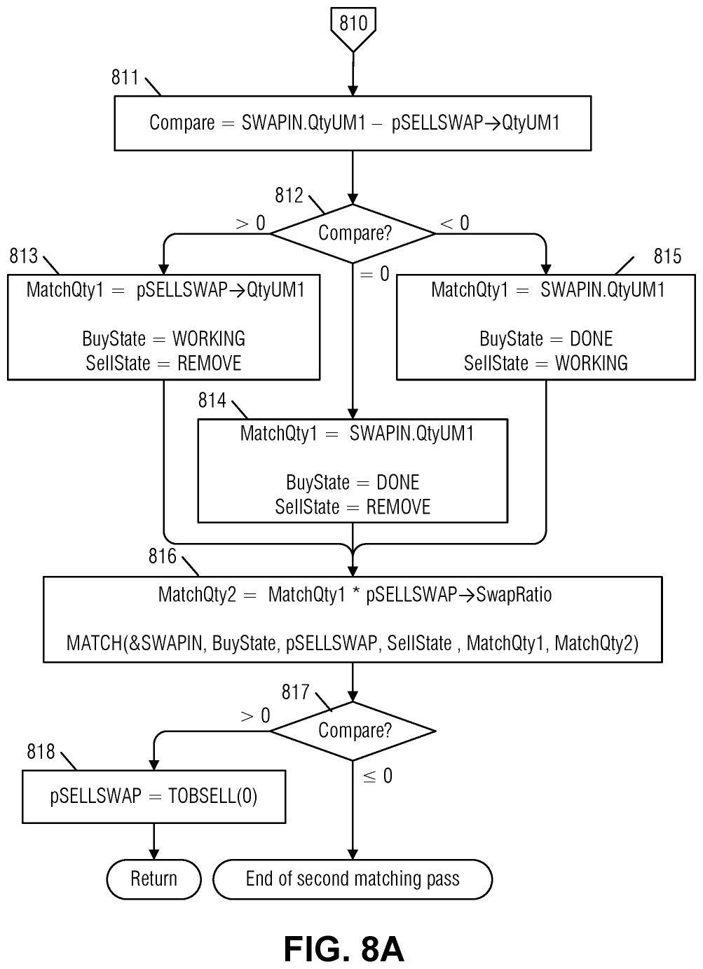

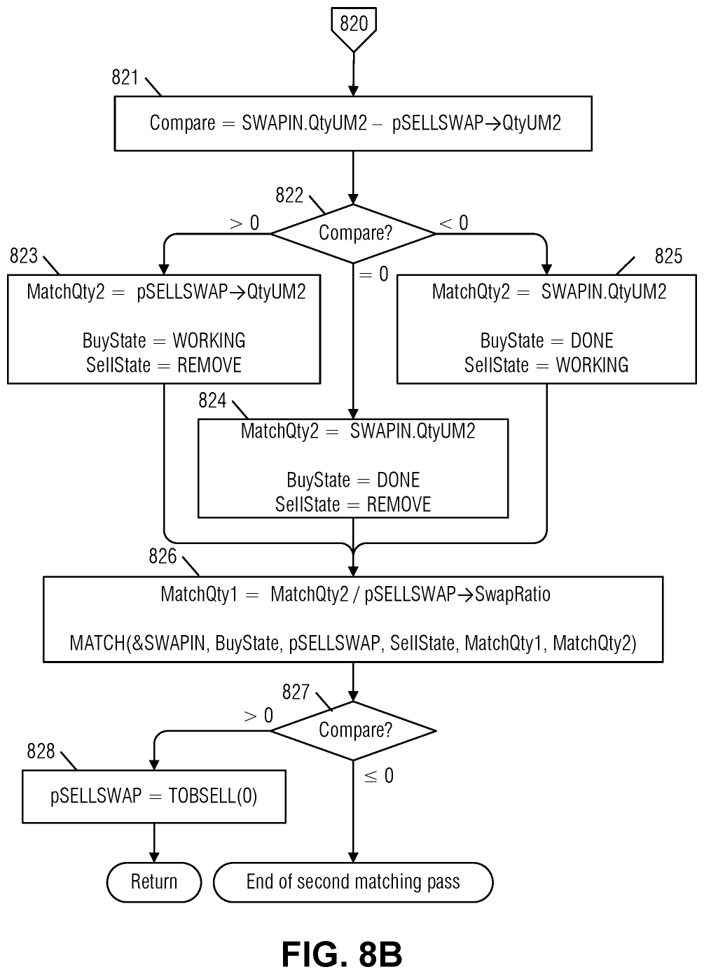

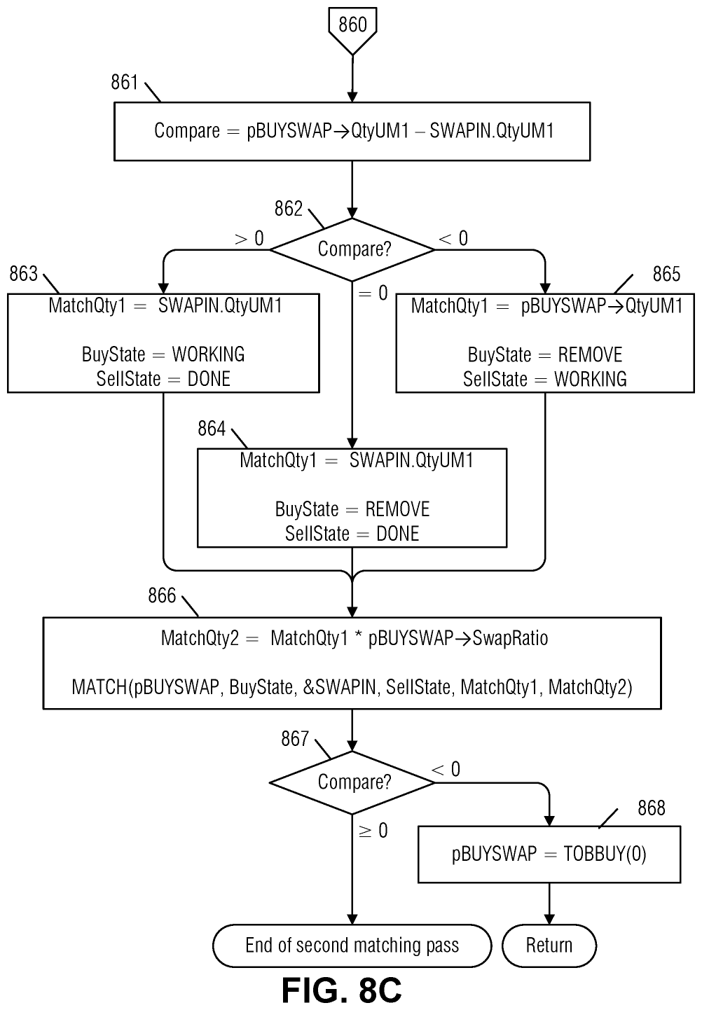

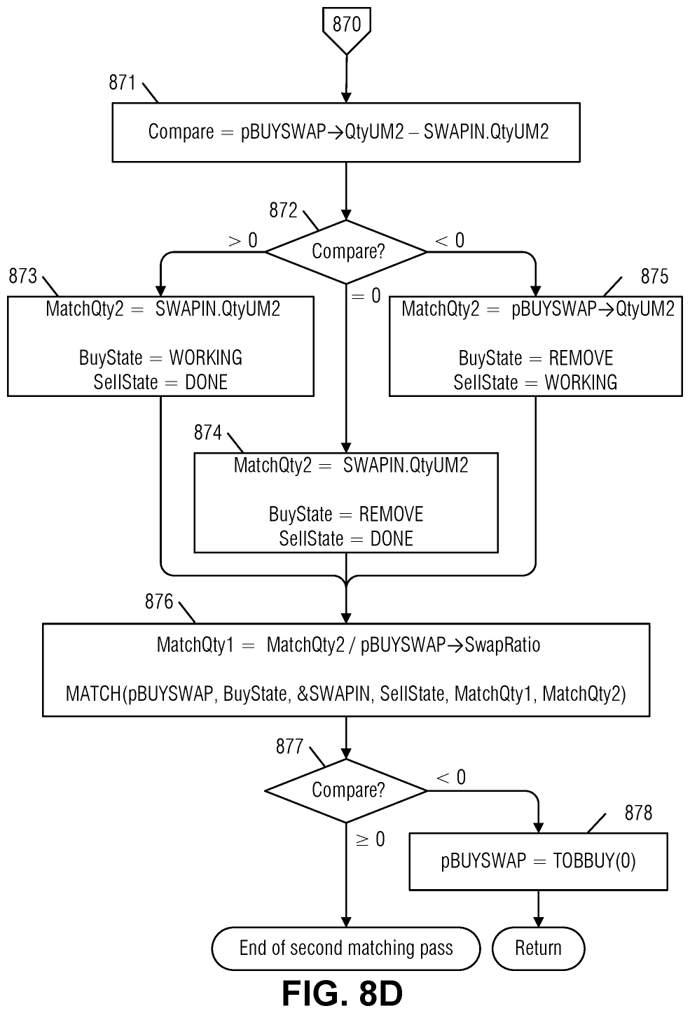

FIG. 8A, FIG. 8B, FIG. 8C, and FIG. 8D illustrate an example of a second matching pass performs actual matching of an inbound swap order, according to an embodiment. Prior to beginning the second matching pass, NAME determines whether (i) SWAPIN will match with any SWAP in the NAME book, (ii) applying the MTP Protocol will result in cancelling any SWAP resting in the NAME book, or (iii) applying the MTP Protocol will result in cancelling SWAPIN. If any of these would occur during the second matching pass, then the second matching pass is performed. Otherwise, the second matching pass may be bypassed, with processing continuing at operation 1000.

The contra side of the NAME book to be matched against SWAPIN depends on SWAPIN.Side. The quantity of SWAPIN to be matched is dependent on the SwapRatio of the SWAP in the resting order book. Table 2 indicates the figures illustrating how NAME manages the four combinations of SWAPIN.Side and SWAPIN.TradedAsset that can arise. The common characteristic of these figures is that the unmatched quantity of SWAPIN.TradedAsset determines when SWAPIN is completely matched.

TABLE 2

| | SWAPIN.TradedAsset = | SWAPIN.TradedAsset = |
|---|---|---|
| | Symbol1 | Symbol2 |
| SWAPIN.Side = | FIG. 8A | FIG. 8B |
| buy | | |
| SWAPIN.Side = | FIG. 8C | FIG. 8D |
| sell | | |

In all four figures, unlike the first matching pass, SWAPIN and any SWAP matched against SWAPIN will be altered during the second matching pass. Unlike the first matching pass, where copies of the BUYSWAP and SELLSWAP were used to avoid altering SWAPIN or SWAPs in the NAME book, SWAPIN and SWAPs in the NAME book may be altered in the second matching pass.

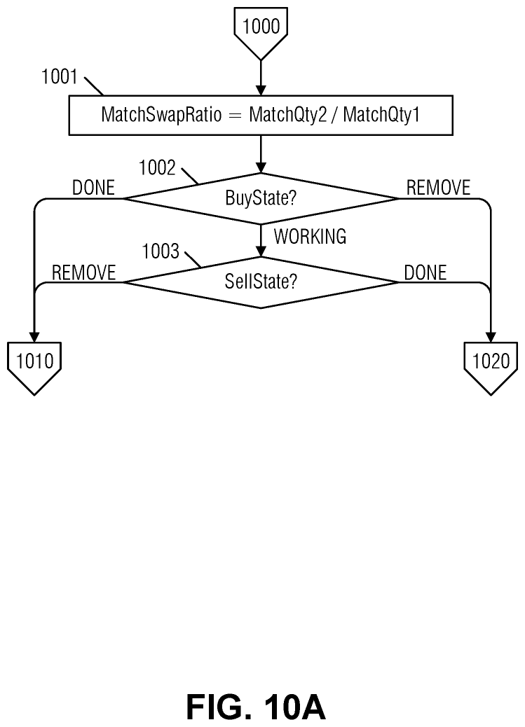

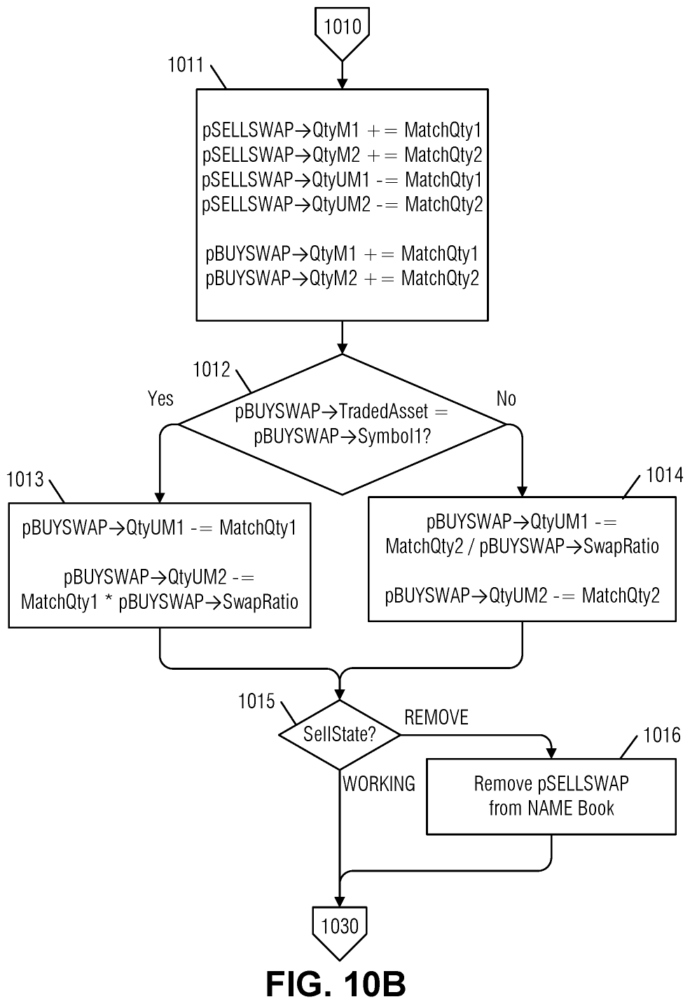

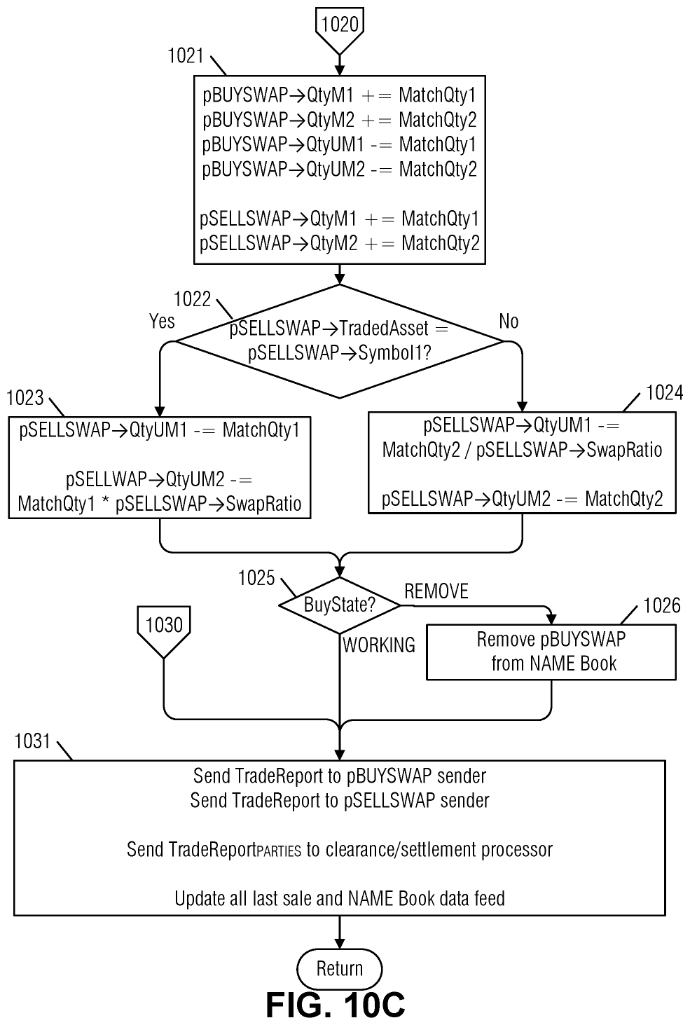

Three functions may be used in the second matching pass: TOPBUY( ), TOPSELL( ), or MATCH( ). TOPBUY( ) and TOPSELL( ) operate as discussed above. MATCH( ) is illustrated in FIGS. 10A-10C. MATCH( ) performs one or more of matching of BUYSWAP and SELLSWAP, managing their respective values of matched and unmatched quantities for each SWAP object's symbols consistent with SWAPIN.TradedAsset (QtyM1, QtyM2, Qty UM1, and QtyUM2), removing fully matched SWAPs from the NAME book, reporting matched trades to the principal parties to the trade, reporting matched trades to the clearance and settlement function, publishing matched trades to satisfy any data feed requirements, or updating NAME book data to satisfy any data feed requirements.

The function TOBBUY(0) is used in the second pass if SWAPIN is a sell-SWAP. TOBBUY(0) returns a pointer to a SWAP object which is currently the highest ranking SWAP on the buy-side of the NAME book or a NULL pointer if there are no remaining buy-side SWAPs in the NAME book.

The function TOBSELL(0) is used in the second pass if SWAPIN is a buy-SWAP. TOBSELL(0) returns a pointer to a SWAP object which is currently the highest ranking SWAP on the sell-side of the NAME book or a NULL pointer if there are no remaining sell-side SWAPs in the NAME book.

The function MATCH(&BUYSWAP, BuyState, &SELLSWAP, SellState, MatchQty1, MatchQty2) is used throughout the second pass. In an example, the MATCH function has six parameters that define a matched trade: (i) &BUYSWAP is the address of buy-SWAP which will be receiving Symbol1 and delivering Symbol2 in the matched trade, (ii) BuyState is the State of BUYSWAP after MATCH( ) is completed, (iii) &SELLSWAP is the address of the SWAP which will be delivering Symbol1 and receiving Symbol2 in the matched trade, (iv) SellState is the State of SELLSWAP after MATCH( ) is completed, (v) MatchQty1 is the quantity of Symbol1 that is being exchanged and (vi) MatchQty2 is the quantity of Symbol2 that is being exchanged.

FIG. 8A is the second matching pass equivalent of FIG. 7A. At operation 810, SWAPIN is the inbound buy-SWAP and pSELLSWAP points to the highest ranked sell-SWAP resting in the NAME book. SWAPIN.QtyUM1 is used to determine when execution of SWAPIN is complete because SWAPIN.TradedAsset is SWAPIN.Symbol1. Processing continues at operation 811.

At operation 811, SWAPIN will be matched with *pSELLSWAP. The unmatched quantities of SWAPIN and *pSELLSWAP are compared. The smaller quantity dictates the quantity to be matched. Processing continues at operation 812.

At operation 812, if compare is greater than zero, then *pSELLSWAP will partially match SWAPIN, and processing continues at operation 813. If compare is equal to zero, then *pSELLSWAP and SWAPIN will fully match each other, and processing continues at operation 814. Otherwise, SWAPIN will partially matched by *pSELLSWAP and processing continues at operation 815.

At operation 813, MatchQty1, the quantity of Symbol1 to be matched, is set to pSELLSWAP→QtyUM1. BuyState is set to WORKING, which indicates that NAME should continue to attempt to match SWAPIN after this match is complete. SellState is set to REMOVE, which indicates that after this match *pSELLSWAP will be complete and should be removed from the NAME book. Processing continues at operation 816.

At operation 814, MatchQty1, the quantity of Symbol1 to be matched, is set to SWAPIN.QtyUM1. BuyState is set to DONE, which indicates that after this match SWAPIN is complete. SellState is set to REMOVE, which indicates that *pSELLSWAP will be complete after this match and should be removed from the NAME book. Processing continues at operation 816.

At operation 815, MatchQty1, the quantity of Symbol1 to be matched, is set to SWAPIN.QtyUM1. BuyState is set to DONE, which indicates that after this match SWAPIN is complete. SellState is set to WORKING, which indicates that after this match the unexecuted portion of *pSELLSWAP should remain in the NAME book. Processing continues at operation 816.

At operation 816, NAME calculates MatchQty2, the quantity of Symbol2 to be matched, as the product of MatchQty1 times pSELLSWAP→SwapRatio. The actual quantities to be matched—MatchQty1 and MatchQty2—are maintained in the proportion dictated by the SwapRatio of the SWAP in the NAME book. This is where potential price improvement can take place. NAME then calls the MATCH( ) function. NAME passes a pointer to the buy-SWAP to be matched, the BuyState after the match, a pointer to the sell-SWAP to be matched, the BuyState after the match, the actual MatchQty1, and the actual MatchQty2. Again, FIGS. 10A-10C and the corresponding text illustrate how MATCH( ) uses these six parameters to implement the match in a manner which correctly determine which Symbol on SWAPIN will be adjusted to reflect any price improvement which may occur. Processing continues at operation 817.

At operation 817, if compare is greater than zero, a portion of SWAPIN remains unmatched, and processing continues at operation 818. Otherwise, the second matching pass is finished, and processing continues to post-second matching passing activity.

At operation 818, the matching engine continues to look for SWAPs in the NAME book to match against SWAPIN. pSELLSWAP is set to point to TOBSELL(0), the highest ranked sell-SWAP in the NAME book or NULL if there is no SWAP on the sell-side of the NAME book. Buy-SWAP and sell-SWAP are evaluated to determine whether they can be matched. If so, 810 will be reentered to simulate that match.

FIG. 8B is the second matching pass equivalent of FIG. 7B. At operation 820, is the entry point to this flowchart. SWAPIN is the inbound buy-SWAP, and pSELLSWAP points to the highest ranked sell-SWAP resting in the NAME book. SWAPIN.QtyUM2 is used to determine when execution of SWAPIN is complete because SWAPIN.TradedAsset is SWAPIN.Symbol2. Processing continues at operation 821.

At operation 821, it has already been determined that SWAPIN will be matched with *pSELLSWAP. The unmatched quantities of SWAPIN and *pSELLSWAP are compared. The smaller quantity dictates the quantity to be matched. Processing continues at operation 822.

At operation 822, if compare is greater than zero, then *pSELLSWAP will partially match SWAPIN, and processing continues at operation 823. If compare is equal to zero, then *pSELLSWAP and SWAPIN will fully match each other, and processing continues at operation 824. Otherwise, SWAPIN will partially matched by *pSELLSWAP and processing continues at operation 825.

At operation 823, MatchQty2, the quantity of Symbol2 to be matched, is set to pSELLSWAP→QtyUM2. BuyState is set to WORKING, which indicates that further attempts to match SWAPIN are made after this match is complete. SellState is set to REMOVE, which indicates that, after this match, *pSELLSWAP will be complete and should be removed from the NAME book. Processing continues at operation 826.

At operation 824, MatchQty2, the quantity of Symbol2 to be matched, is set to SWAPIN.QtyUM2. BuyState is set to DONE, which indicates that SWAPIN is complete. SellState is set to REMOVE, which indicates that *pSELLSWAP will be complete after this match and should be removed from the NAME book. Processing continues at operation 826.

At operation 825, MatchQty2, the quantity of Symbol2 to be matched, is set to SWAPIN.QtyUM2. BuyState is set to DONE, which indicates that SWAPIN is complete. SellState is set to WORKING, which indicates that, after this match, the unexecuted portion of *pSELLSWAP should remain in the NAME book. Processing continues at operation 826.

At operation 826, MatchQty1, the quantity of Symbol1 to be matched, is calculated as MatchQty2 divided pSELLSWAP→SwapRatio. The actual quantities to be matched—MatchQty1 and MatchQty2—are thus kept in the proportion defined by the SwapRatio of the SWAP in the NAME book. This is where potential price improvement can take place. The MATCH( ) function may then be called. A pointer to the buy-SWAP to be matched, the BuyState after the match, a pointer to the sell-SWAP to be matched, the BuyState after the match, the actual MatchQty1, and the actual MatchQty2 are passed to MATCH( ). As described below, MATCH( ) uses these six parameters to implement the match in a manner that correctly determines which Symbol on SWAPIN will be adjusted to reflect any price improvement. Processing continues at operation 827.

At operation 827, if compare is greater than zero, a portion of SWAPIN remains unmatched, and processing continues at operation 828. Otherwise, the second matching pass is finished, and processing continues to pos-second match activity.

At operation 828, additional SWAPs in the NAME book are sought (e.g., looked for or searched for) to match against SWAPIN. pSELLSWAP is set to point to TOBSELL(0), the highest ranked sell-SWAP in the NAME book or NULL if there is no SWAP on the sell-side of the NAME book. Buy-SWAP and sell-SWAP are evaluated to determine whether they can be matched. If so, 820 will be reentered to perform that match.

FIG. 8C is the second matching pass equivalent of FIG. 7C. At operation 860, is the entry point to this flowchart. pBUYSWAP points to the highest ranked buy-SWAP resting in the NAME book, and SWAPIN is the inbound sell-SWAP. SWAPIN.QtyUM1 is used to determine when execution of SWAPIN is complete because SWAPIN.TradedAsset is SWAPIN.Symbol1. Processing continues at operation 861.

At operation 861, it has already been determined that *pBUYSWAP will be matched with SWAPIN. The unmatched quantities of *pBUYSWAP and SWAPIN are compared. The smaller quantity dictates the quantity to be matched. Processing continues at operation 862.

At operation 862, if compare is greater than zero, then *pBUYSWAP will partially be matched with SWAPIN, and processing continues at operation 863. If compare is equal to zero, then *pBUYSWAP and SWAPIN will fully match each other, and processing continues at operation 864. Otherwise, SWAPIN will partially matched by *pBUYSWAP and processing continues at operation 865.

At operation 863, MatchQty1, the quantity of Symbol1 to be matched, is set to SWAPIN.QtyUM1. BuyState is set to WORKING which indicates after this match *pSELLSWAP will be incomplete and should remain the NAME book. SellState is set to DONE, which indicates that, after this match, SWAPIN will be complete. Processing continues at operation 866.

At operation 864, MatchQty1, the quantity of Symbol1 to be matched, is set to SWAPIN.QtyUM1. BuyState is set to REMOVE, which indicates that *pBUYSWAP will be complete after this match and should be removed from the NAME book. SellState is set to DONE, which indicates that, after this match, SWAPIN is complete. Processing continues at operation 866.

At operation 865, MatchQty1, the quantity of Symbol1 to be matched, is set to SWAPIN.QtyUM1. BuyState is set to REMOVE, which indicates that, after this match, *pBUYSWAP will be complete and should be removed from the NAME book. SellState is set to WORKING, which indicates that NAME should continue to attempt to match SWAPIN after this match is complete. Processing continues at operation 866.

At operation 866, MatchQty2, the quantity of Symbol2 to be matched, is calculated as the product of MatchQty1 times pBUYSWAP→SwapRatio. The actual quantities to be matched—MatchQty1 and MatchQty2—are thus maintained in proportion to the SwapRatio of the SWAP in the NAME book. The MATCH( ) function may then be called with a pointer to the buy-SWAP to be matched, the BuyState after the match, a pointer to the sell-SWAP to be matched, the BuyState after the match, the actual MatchQty1, and the actual MatchQty2. Processing continues at operation 867.

At operation 867, if compare is less than zero, a portion of SWAPIN remains unmatched, and processing continues at operation 868. Otherwise, the second matching pass is finished, and processing continues to pos-second matching pass activity.

At operation 868, additional buy SWAPINs are sought in the NAME book to match against SWAPIN. pBUYSWAP is set to point to TOBBUY(0), the highest ranked buy-SWAP in the NAME book or NULL if there is no SWAP on the buy-side of the NAME book. Buy-SWAP and sell-SWAP are evaluated to determine whether they can be matched. If so, 860 will be reentered to simulate that match.

FIG. 8D is the second matching pass equivalent of FIG. 7D. At operation 870, pBUYSWAP points to the highest ranked buy-SWAP resting in the NAME book, and SWAPIN is the inbound sell-SWAP. SWAPIN.QtyUM2 is used to determine when execution of SWAPIN is complete because SWAPIN.TradedAsset is SWAPIN.Symbol2. Processing continues at operation 871.

At operation 871, it has already been determined that *pBUYSWAP will be matched with SWAPIN. The unmatched quantities of *pBUYSWAP and SWAPIN are compared. The smaller quantity dictates the quantity to be matched. Processing continues at operation 872.

At operation 872, if compare is greater than zero, then *pBUYSWAP will partially be matched with SWAPIN, and processing continues at operation 873. If compare is equal to zero, then *pBUYSWAP and SWAPIN will fully match each other, and processing continues at operation 874. Otherwise, SWAPIN will partially matched by *pBUYSWAP and processing continues at operation 875.

At operation 873, MatchQty2, the quantity of Symbol2 to be matched, is set to SWAPIN.QtyUM2. BuyState is set to WORKING, which indicates that, after this match, *pBUYSWAP will be incomplete and should remain the NAME book. SellState is set to DONE, which indicates that, after this match, SWAPIN will be complete. Processing continues at operation 876.

At operation 874, MatchQty2, the quantity of Symbol2 to be matched, is set to SWAPIN.QtyUM2. BuyState is set to REMOVE, which indicates that *pBUYSWAP will be complete after this match and should be removed from the NAME book. SellState is set to DONE, which indicates that, after this match, SWAPIN is complete. Processing continues at operation 876.

At operation 875, MatchQty2, the quantity of Symbol2 to be matched, is set to SWAPIN.QtyUM2. BuyState is set to REMOVE, which indicates that, after this match, *pBUYSWAP will be complete and should be removed from the NAME book. SellState is set to WORKING, which indicates that NAME should continue to attempt to match SWAPIN after this match is complete. Processing continues at operation 876.

At operation 876, MatchQty2, the quantity of Symbol2 to be matched, is calculated as MatchQty1 divided by pBUYSWAP→SwapRatio. Again, the actual quantities to be matched—e.g., MatchQty1 and MatchQty2—are kept in the proportion dictated by the SwapRatio of the SWAP in the NAME book. The MATCH( ) function may then be called with a pointer to the buy-SWAP to be matched, the BuyState after the match, a pointer to the sell-SWAP to be matched, the BuyState after the match, the actual MatchQty1, and the actual MatchQty2. Processing continues at operation 877.

At operation 877, if compare is less than zero, a portion of SWAPIN remains unmatched, and processing continues at operation 878. Otherwise, the second matching pass is finished, and processing continues to pos-second matching pass activity.

At operation 878, additional buy-SWAPs are sought in the NAME book to match against SWAPIN. pBUYSWAP is set to point to TOBBUY(0), the highest ranked buy-SWAP in the NAME book or NULL if there is no SWAP on the buy-side of the NAME book. Buy-SWAP and Sell-SWAPs are evaluated to determine whether they can be matched. If so, 860 will be reentered to perform that match.

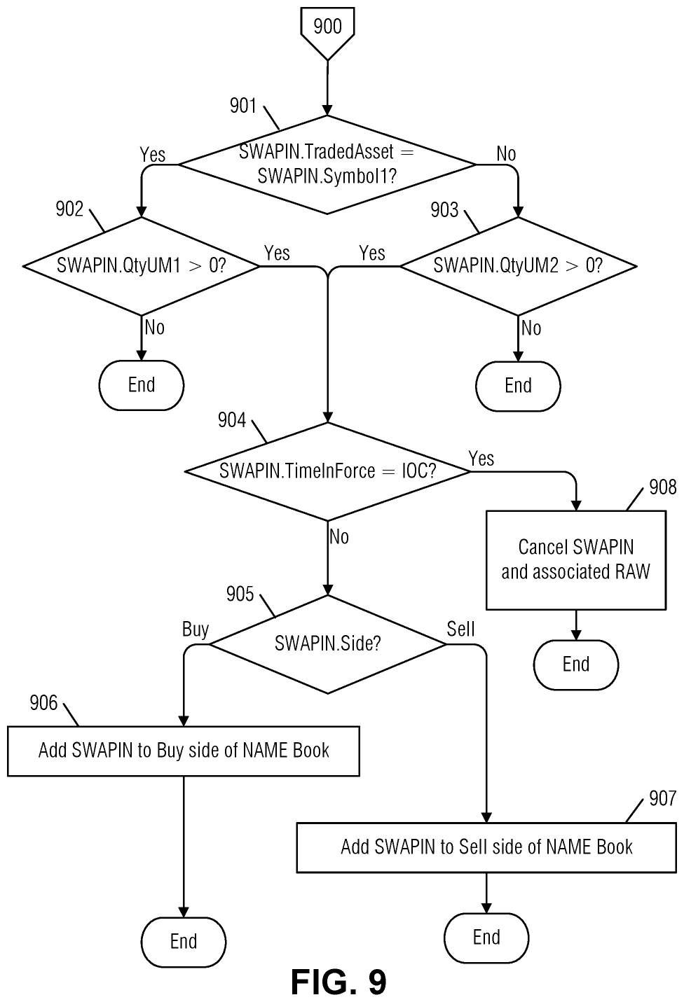

In an example, when the second matching pass has been completed or bypassed, processing continues at operation 900 of FIG. 9 to determine how to end the second pass. Processing continues at operation 901.

At operation 901, NAME evaluates SWAPIN.TradedAsset. This operation is not necessary in other systems that default to either the first Symbol or the second Symbol in the RAW format to determine when a RAW is fully matched. NAME uses SWAPIN.TradedAsset to direct the NAME matching engine which allows the RAW sender the flexibility ability to select which Symbol's quantity is used by NAME to determine when the associated SWAP is fully matched. If SWAPIN.TradedAsset equals SWAPIN.Symbol1, processing continues at operation 902. Otherwise, processing continues at operation 903.

At operation 902, SWAPIN. TradedAsset equals SWAPIN.Symbol1. If SWAPIN.QtyUM1 is greater than zero, SWAPIN has not been fully matched, and processing continues at operation 904. Otherwise, processing ends.

At operation 903, SWAPIN.TradedAsset equals SWAPIN.Symbol2. If SWAPIN.QtyUM2 is greater than zero, SWAPIN has not been fully matched, and processing continues at operation 904. Otherwise, processing ends.

At operation 904, if SWAPIN.TimeInForce is IOC, the SWAPIN is canceled, and processing continues at operation 908. Otherwise, processing continues at operation 905.

At operation 905, SWAPIN. SWAPIN is buy, processing continues at operation 906. Otherwise, processing continues at operation 907.

At operation 906, SWAPIN is not fully matched, NAME adds SWAPIN to the buy-side of the NAME book. Processing ends.

At operation 907, SWAPIN is not fully matched, and NAME adds SWAPIN to the sell-side of the NAME book. Processing ends.

At operation 908, NAME cancels the SWAPIN and the RAW format that is associated with SWAPIN, and processing ends.

FIG. 10A, FIG. 10B, and FIG. 10C illustrate an example of a match technique, MATCH. This technique may be used to complete matching. MATCH is passed six parameters: (1) a pointer to a buy-SWAP, (2) instruction on the disposition of the buy-SWAP after completing the match, (3) a pointer to a sell-SWAP, (4) instruction on the disposition of the sell-SWAP after completing the match, (5) the quantity of SWAPIN.Symbol1 to match, and (6) the quantity of SWAPIN.Symbol2 to match.

The entry point for MATCH( ) is at operation 1000 in FIG. 10A. Processing continues at operation 1001.

At operation 1001, the MatchSwapRatio is calculated as MatchQty2 divided by MatchQty1. Processing continues at operation 1002.

At operation 1002, if the buy-SWAP being matched has a BuyState of DONE after the match, it indicates SWAPIN. In an example, the DONE state is reserved for SWAPIN. Processing continues at operation 1010. If the buy-SWAP being matched has a BuyState of REMOVE after the match, it indicates a SWAP resting in the NAME book. In an example, the REMOVE state is reserved for SWAPs resting in the NAME book. Processing continues at operation 1020. Otherwise, processing continues at operation 1003.

At operation 1003, if the matched sell-SWAP has a sell state of DONE after the match, it indicates SWAPIN. In an example, the DONE state is reserved for SWAPIN. Processing continues at operation 1020 in FIG. 10C. The matched sell-SWAP has a sell state of REMOVE after the match and has a SWAP resting in the NAME book. In an example, the REMOVE state is reserved for SWAPs resting in the NAME book. Processing continues at operation 1010 in FIG. 10B.

At operation 1010, the buy-SWAP is the inbound SWAPIN, and the sell-SWAP is resting in the NAME book. Processing continues at operation 1011.

At operation 1011, pBUYSWAP→QtyM1 and pSELLSWAP→QtyM1 are incremented by MatchQty1. pBUYSWAP→QtyM2 and pSELLSWAP→QtyM2 are incremented by MatchQty2. Because pSELLSWAP is resting in the NAME book, pSELLSWAP→SwapRatio is equal to MatchedQty2 divided by MatchedQty1. Therefore, pSELLSWAP→QtyUM1 is decremented by MatchQty1, and pSELLSWAP→QtyUM2 is decremented by MatchQty2. It is SWAPIN which may need an adjustment if there is price improvement. Processing continues at operation 1012.

At operation 1012, pBUYSWAP points to SWAPIN. If pBUYSWAP→TradedAsset equals pBUYSWAP→Symbol1, processing continues at operation 1013. Otherwise, pBUYSWAP→TradedAsset equals pBUYSWAP→Symbol2, and processing continues at operation 1014.

At operation 1013, pBUYSWAP.TradedAsset equals Symbol1. Therefore, pBUYSWAP→QtyUM1 is not adjusted, and pBUYSWAP→QtyUM2 may need to be adjusted. pBUYSWAP→QtyUM1 is decremented by MatchQty1. pBUYSWAP→QtyUM2 is decremented by MatchQty1 times pBUYSWAP→SwapRatio. This is where an adjustment for price improvement would be made. Processing continues at operation 1015.

At operation 1014, pBUYSWAP.TradedAsset equals Symbol2. Therefore, pBUYSWAP→QtyUM1 may need to be adjusted, and pBUYSWAP→QtyUM2 is not adjusted. For example, pBUYSWAP→QtyUM1 is decremented by MatchQty2 divided by pBUYSWAP→SwapRatio, and pBUYSWAP→QtyUM2 is decremented by MatchQty2. This is where an adjustment for price improvement would be made. Processing continues at operation 1015.

At operation 1015, if SellState is REMOVE, processing continues at operation 1016. Otherwise, processing continues at operation 1030 in FIG. 10C.

At operation 1016 in FIG. 10C, pSELLSWAP is removed from the NAME book. Processing continues at operation 1030 in FIG. 10C.

At operation 1020, the buy-SWAP is resting in the NAME book, and the sell-SWAP is the inbound SWAPIN.

At operation 1021, pBUYSWAP→QtyM1 and pSELLSWAP→QtyM1 are incremented by MatchQty1. pBUYSWAP→QtyM2 and pSELLSWAP→QtyM2 are incremented by MatchQty2. Because pBUYSWAP is resting in the NAME book, pSELLSWAP→SwapRatio is equal to MatchedQty2 divided by MatchedQty1. Therefore, pBUYSWAP→QtyUM1 is decremented by MatchQty1, and pBUYSWAP→QtyUM2 is decremented by MatchQty2. It is SWAPIN which may need an adjustment if there is price improvement. Processing continues at operation 1022.

At operation 1022, pSELLSWAP points to SWAPIN. If pSELLSWAP→TradedAsset equals pSELLSWAP→Symbol1, processing continues at operation 1023. Otherwise, pSELLSWAP→TradedAsset equals pSELLSWAP→Symbol2, and processing continues at operation 1024.

At operation 1023, pSELLSWAP.TradedAsset equals Symbol1. Therefore, pSELLSWAP→QtyUM1 is not adjusted, and pSELLSWAP→QtyUM2 may need to be adjusted. pSELLSWAP→QtyUM1 is decremented by MatchQty1. pSELLSWAP→QtyUM2 is decremented by MatchQty1 times pSELLSWAP→SwapRatio. This is where an adjustment for price improvement would be made. Processing continues at operation 1025.

At operation 1024, pSELLSWAP.TradedAsset equals Symbol2. Therefore, pSELLSWAP→QtyUM1 may need to be adjusted, and pSELLSWAP→QtyUM2 is not adjusted. pSELLSWAP→QtyUM1 is decremented by MatchQty2 divided by pSELLSWAP→SwapRatio. pSELLSWAP→QtyUM2 is decremented by MatchQty2. This is where an adjustment for price improvement would be made. Processing continues at operation 1025.

At operation 1025, if BuyState is REMOVE, processing continues at operation 1026. Otherwise, processing continues at operation 1031.

At operation 1026, pBUYSWAP is removed from the NAME book. Processing continues at operation 1031.

At operation 1031, a TradeReport (absent counterparty information) is sent to the parties who sent the RAWs which become the SWAPs that are being matched. A TradeReport (including counterparty information) to the clearance or settlement processor. All last sale and NAME book data feeds are updated. Processing returns to the location from which MATCH( ) was called.

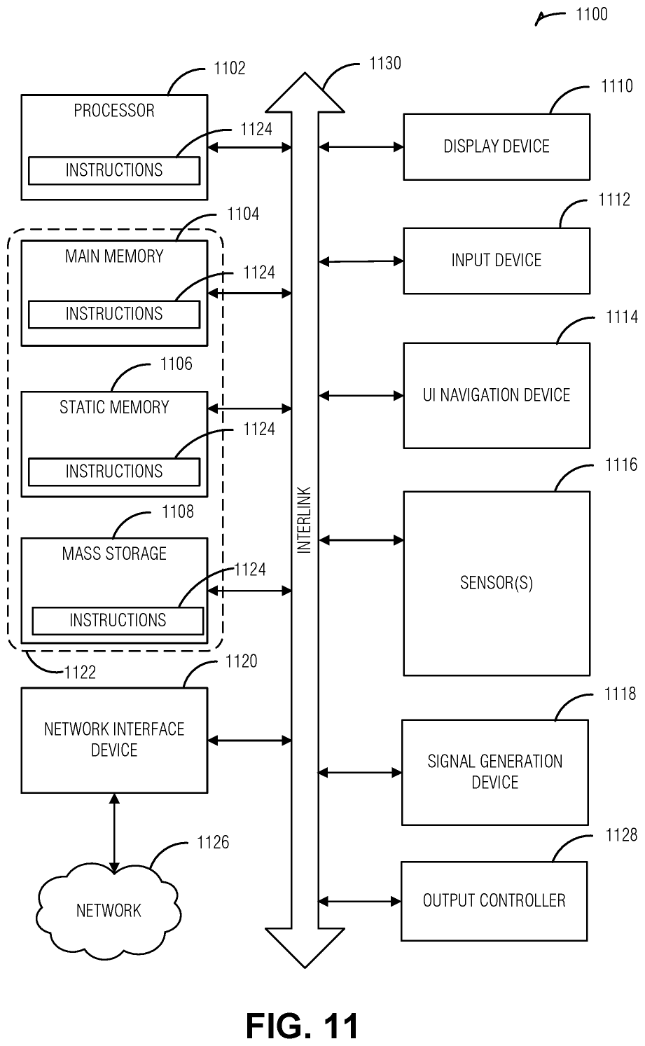

FIG. 11 illustrates a block diagram of an example machine 1100 upon which any one or more of the techniques (e.g., methodologies) discussed herein may perform. Examples, as described herein, may include, or may operate by, logic or a number of components, or mechanisms in the machine 1100. Circuitry (e.g., processing circuitry) is a collection of circuits implemented in tangible entities of the machine 1100 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 1100 follow.

In alternative embodiments, the machine 1100 may operate as a standalone device or may be connected (e.g., networked) to other machines. In a networked deployment, the machine 1100 may operate in the capacity of a server machine, a client machine, or both in server-client network environments. In an example, the machine 1100 may act as a peer machine in peer-to-peer (P2P) (or other distributed) network environment. The machine 1100 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 1100 may include a hardware processor 1102 (e.g., a central processing unit (CPU), a graphics processing unit (GPU), a hardware processor core, or any combination thereof), a main memory 1104, a static memory (e.g., memory or storage for firmware, microcode, a basic-input-output (BIOS), unified extensible firmware interface (UEFI), etc.) 1106, and mass storage 1108 (e.g., hard drives, tape drives, flash storage, or other block devices) some or all of which may communicate with each other via an interlink (e.g., bus) 1130. The machine 1100 may further include a display unit 1110, an alphanumeric input device 1112 (e.g., a keyboard), and a user interface (UI) navigation device 1114 (e.g., a mouse). In an example, the display unit 1110, input device 1112 and UI navigation device 1114 may be a touch screen display. The machine 1100 may additionally include a storage device (e.g., drive unit) 1108, a signal generation device 1118 (e.g., a speaker), a network interface device 1120, and one or more sensors 1116, such as a global positioning system (GPS) sensor, compass, accelerometer, or other sensor. The machine 1100 may include an output controller 1128, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 1102, the main memory 1104, the static memory 1106, or the mass storage 1108 may be, or include, a machine readable medium 1122 on which is stored one or more sets of data structures or instructions 1124 (e.g., software) embodying or utilized by any one or more of the techniques or functions described herein. The instructions 1124 may also reside, completely or at least partially, within any of registers of the processor 1102, the main memory 1104, the static memory 1106, or the mass storage 1108 during execution thereof by the machine 1100. In an example, one or any combination of the hardware processor 1102, the main memory 1104, the static memory 1106, or the mass storage 1108 may constitute the machine readable media 1122. While the machine readable medium 1122 is illustrated as a single medium, the term “machine readable medium” may include a single medium or multiple media (e.g., a centralized or distributed database, and/or associated caches and servers) configured to store the one or more instructions 1124.

The term “machine readable medium” may include any medium that is capable of storing, encoding, or carrying instructions for execution by the machine 1100 and that cause the machine 1100 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

In an example, information stored or otherwise provided on the machine readable medium 1122 may be representative of the instructions 1124, such as instructions 1124 themselves or a format from which the instructions 1124 may be derived. This format from which the instructions 1124 may be derived may include source code, encoded instructions (e.g., in compressed or encrypted form), packaged instructions (e.g., split into multiple packages), or the like. The information representative of the instructions 1124 in the machine readable medium 1122 may be processed by processing circuitry into the instructions to implement any of the operations discussed herein. For example, deriving the instructions 1124 from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 1124.

In an example, the derivation of the instructions 1124 may include assembly, compilation, or interpretation of the information (e.g., by the processing circuitry) to create the instructions 1124 from some intermediate or preprocessed format provided by the machine readable medium 1122. The information, when provided in multiple parts, may be combined, unpacked, and modified to create the instructions 1124. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 1124 may be further transmitted or received over a communications network 1126 using a transmission medium via the network interface device 1120 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), LoRa/LoRaWAN, or satellite communication networks, mobile telephone networks (e.g., cellular networks such as those complying with 3G, 4G LTE/LTE-A, or 5G standards), Plain Old Telephone (POTS) networks, and wireless data networks (e.g., Institute of Electrical and Electronics Engineers (IEEE) 802.11 family of standards known as Wi-Fi®, IEEE 802.15.4 family of standards, peer-to-peer (P2P) networks, among others. In an example, the network interface device 1120 may include one or more physical jacks (e.g., Ethernet, coaxial, or phone jacks) or one or more antennas to connect to the communications network 1126. In an example, the network interface device 1120 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1100, and includes digital or analog communications signals or other intangible medium to facilitate communication of such software. A transmission medium is a machine readable medium.

### Additional Notes & Examples

Example 1 is a computing system for swap order normalization, the computing system comprising: a memory including instructions; and processing circuitry that, when in operation, is configured by the instructions to: receive a first order, the first order being a data structure with a first symbol, a first quantity corresponding to the first symbol, a second symbol, a second quantity corresponding to the second symbol, and an indication of which of the first symbol or the second symbol is a traded asset; convert the order into a first normalized order based on the indication of the traded asset, including the processing circuitry to: order the first symbol and the second symbol to create a first normalized symbol that is less than a second normalized symbol based on an ordering criterion; provide a ranking-and-matching criterion; and indicate which of the first normalized symbol or the second normalized symbol is the traded asset; store the first normalized order into a resting order book; receive a second order; convert the second order into a second normalized order; match the second normalized order to the first normalized order in the resting order book; and complete the first normalized order or the second normalized order, based on the matching of the second normalized order to the first normalized order, to create a completed order, a traded asset of the completed order being completely traded.

In Example 2, the subject matter of Example 1 includes, wherein the instructions further configured the processing circuitry to: remove the first normalized order from the resting order book in response to completing the first normalized order, wherein the completed order is the first normalized order.

In Example 3, the subject matter of Example 2 includes, wherein the instructions further configured the processing circuitry to: adjust a traded asset quantity in the second normalized order in response to completing the first normalized order.

In Example 4, the subject matter of Example 3 includes, wherein the instructions further configured the processing circuitry to: continue to match the second normalized order against additional normalized orders in the resting order book until a stopping condition is met.

In Example 5, the subject matter of Example 4 includes, wherein the stopping condition is completion of the second normalized order.

In Example 6, the subject matter of Examples 4-5 includes, wherein the stopping condition is a failure to match the second normalized order with normalized orders remaining in the resting order book.

In Example 7, the subject matter of Example 6 includes, wherein the instructions further configured the processing circuitry to: store the second normalized order into the resting order book.

In Example 8, the subject matter of Examples 1-7 includes, wherein the first symbol is greater than the second symbol and wherein, to order the first symbol and the second symbols, the processing circuitry switches an order side in the first normalized order.

In Example 9, the subject matter of Example 8 includes, wherein the order type of the first order is buy and wherein, to switch the order side, the processing circuitry sets the order side of the first normalized order to sell.

In Example 10, the subject matter of Examples 8-9 includes, wherein the order type of the first order is sell and wherein, to switch the order side, the processing circuitry sets the order side of the first normalized order to buy.

In Example 11, the subject matter of Examples 1-10 includes, wherein the ranking-and-matching criterion is based on a swap ratio.

In Example 12, the subject matter of Example 11 includes, wherein the second normalized order is a buy order, and wherein a higher swap ratio is ranked higher.

In Example 13, the subject matter of Examples 11-12 includes, wherein the second normalized order is a sell order, and wherein a lower swap ratio is ranked higher.

In Example 14, the subject matter of Examples 11-13 includes, wherein the swap ratio is calculated by division of a quantity corresponding to a second normalized order symbol with a quantity corresponding to a first normalized order symbol.

In Example 15, the subject matter of Examples 11-14 includes, wherein, to match the second normalized order to the first normalized order in the resting order book, the processing circuitry ensures that a swap ratio for the second normalized order meets a swap ratio for the first normalized order.

In Example 16, the subject matter of Example 15 includes, wherein, to complete the first normalized order or the second normalized order, the processing circuitry maintains the swap ratio of the second normalized order when decrementing and incrementing quantities in the second normalized order.

In Example 17, the subject matter of Examples 1-16 includes, wherein the indication of which of the first symbol or the second symbol is the traded asset is implicit in the first order based on symbol position in the first order.

In Example 18, the subject matter of Example 17 includes, wherein an initial position in a symbol position sequence indicates the traded asset.

In Example 19, the subject matter of Examples 1-18 includes, wherein the indication of which of the first symbol or the second symbol is the traded asset is explicitly indicated in the first order by a marker.

In Example 20, the subject matter of Examples 1-19 includes, wherein the ranking-and-matching criterion is based on an arrival time of an order.

In Example 21, the subject matter of Example 20 includes, wherein the arrival time is a secondary ranking criterion, and wherein a swap ratio is a primary ranking criterion.

In Example 22, the subject matter of Examples 20-21 includes, wherein, to store the first normalized order into the resting order book, the processing circuitry stores an arrival time for the first order.

Example 23 is a method for swap order normalization, the method comprising: receiving a first order, the first order being a data structure with a first symbol, a first quantity corresponding to the first symbol, a second symbol, a second quantity corresponding to the second symbol, and an indication of which of the first symbol or the second symbol is a traded asset; converting the order into a first normalized order based on the indication of the traded asset, the converting including: ordering the first symbol and the second symbol to create a first normalized symbol that is less than a second normalized symbol based on an ordering criterion; providing a ranking-and-matching criterion; and indicating which of the first normalized symbol or the second normalized symbol is the traded asset; storing the first normalized order into a resting order book; receiving a second order; converting the second order into a second normalized order; matching the second normalized order to the first normalized order in the resting order book; and completing the first normalized order or the second normalized order, based on the matching of the second normalized order to the first normalized order, to create a completed order, a traded asset of the completed order being completely traded.

In Example 24, the subject matter of Example 23 includes, removing the first normalized order from the resting order book in response to completing the first normalized order, wherein the completed order is the first normalized order.

In Example 25, the subject matter of Example 24 includes, adjusting a traded asset quantity in the second normalized order in response to completing the first normalized order.

In Example 26, the subject matter of Example 25 includes, continuing to match the second normalized order against additional normalized orders in the resting order book until a stopping condition is met.

In Example 27, the subject matter of Example 26 includes, wherein the stopping condition is completion of the second normalized order.

In Example 28, the subject matter of Examples 26-27 includes, wherein the stopping condition is a failure to match the second normalized order with normalized orders remaining in the resting order book.

In Example 29, the subject matter of Example 28 includes, storing the second normalized order into the resting order book.

In Example 30, the subject matter of Examples 23-29 includes, wherein the first symbol is greater than the second symbol and wherein ordering the first symbol and the second symbols includes switching an order side in the first normalized order.

In Example 31, the subject matter of Example 30 includes, wherein the order type of the first order is buy and wherein switching the order side includes setting the order side of the first normalized order to sell.

In Example 32, the subject matter of Examples 30-31 includes, wherein the order type of the first order is sell and wherein switching the order side includes setting the order side of the first normalized order to buy.

In Example 33, the subject matter of Examples 23-32 includes, wherein the ranking-and-matching criterion is based on a swap ratio.

In Example 34, the subject matter of Example 33 includes, wherein the second normalized order is a buy order, and wherein a higher swap ratio is ranked higher.

In Example 35, the subject matter of Examples 33-34 includes, wherein the second normalized order is a sell order, and wherein a lower swap ratio is ranked higher.

In Example 36, the subject matter of Examples 33-35 includes, wherein the swap ratio is calculated by dividing a quantity corresponding to a second normalized order symbol with a quantity corresponding to a first normalized order symbol.

In Example 37, the subject matter of Examples 33-36 includes, wherein matching the second normalized order to the first normalized order in the resting order book includes ensuring that a swap ratio for the second normalized order meets a swap ratio for the first normalized order.

In Example 38, the subject matter of Example 37 includes, wherein completing the first normalized order or the second normalized order includes maintaining the swap ratio of the second normalized order when decrementing and incrementing quantities in the second normalized order.

In Example 39, the subject matter of Examples 23-38 includes, wherein the indication of which of the first symbol or the second symbol is the traded asset is implicit in the first order based on symbol position in the first order.

In Example 40, the subject matter of Example 39 includes, wherein an initial position in a symbol position sequence indicates the traded asset.

In Example 41, the subject matter of Examples 23-40 includes, wherein the indication of which of the first symbol or the second symbol is the traded asset is explicitly indicated in the first order by a marker.

In Example 42, the subject matter of Examples 23-41 includes, wherein the ranking-and-matching criterion is based on an arrival time of an order.

In Example 43, the subject matter of Example 42 includes, wherein the arrival time is a secondary ranking criterion, and wherein a swap ratio is a primary ranking criterion.

In Example 44, the subject matter of Examples 42-43 includes, wherein storing the first normalized order into the resting order book includes storing an arrival time for the first order.

Example 45 is a machine-readable medium including instructions for swap order normalization, the instructions, when executed by processing circuitry, cause the processing circuitry to perform operations comprising: receiving a first order, the first order being a data structure with a first symbol, a first quantity corresponding to the first symbol, a second symbol, a second quantity corresponding to the second symbol, and an indication of which of the first symbol or the second symbol is a traded asset; converting the order into a first normalized order based on the indication of the traded asset, the converting including: ordering the first symbol and the second symbol to create a first normalized symbol that is less than a second normalized symbol based on an ordering criterion; providing a ranking-and-matching criterion; and indicating which of the first normalized symbol or the second normalized symbol is the traded asset; storing the first normalized order into a resting order book; receiving a second order; converting the second order into a second normalized order; matching the second normalized order to the first normalized order in the resting order book; and completing the first normalized order or the second normalized order, based on the matching of the second normalized order to the first normalized order, to create a completed order, a traded asset of the completed order being completely traded.

In Example 46, the subject matter of Example 45 includes, wherein the operations comprise: removing the first normalized order from the resting order book in response to completing the first normalized order, wherein the completed order is the first normalized order.

In Example 47, the subject matter of Example 46 includes, wherein the operations comprise: adjusting a traded asset quantity in the second normalized order in response to completing the first normalized order.

In Example 48, the subject matter of Example 47 includes, wherein the operations comprise: continuing to match the second normalized order against additional normalized orders in the resting order book until a stopping condition is met.

In Example 49, the subject matter of Example 48 includes, wherein the stopping condition is completion of the second normalized order.

In Example 50, the subject matter of Examples 48-49 includes, wherein the stopping condition is a failure to match the second normalized order with normalized orders remaining in the resting order book.

In Example 51, the subject matter of Example 50 includes, wherein the operations comprise: storing the second normalized order into the resting order book.

In Example 52, the subject matter of Examples 45-51 includes, wherein the first symbol is greater than the second symbol and wherein ordering the first symbol and the second symbols includes switching an order side in the first normalized order.

In Example 53, the subject matter of Example 52 includes, wherein the order type of the first order is buy and wherein switching the order side includes setting the order side of the first normalized order to sell.

In Example 54, the subject matter of Examples 52-53 includes, wherein the order type of the first order is sell and wherein switching the order side includes setting the order side of the first normalized order to buy.

In Example 55, the subject matter of Examples 45-54 includes, wherein the ranking-and-matching criterion is based on a swap ratio.

In Example 56, the subject matter of Example 55 includes, wherein the second normalized order is a buy order, and wherein a higher swap ratio is ranked higher.

In Example 57, the subject matter of Examples 55-56 includes, wherein the second normalized order is a sell order, and wherein a lower swap ratio is ranked higher.

In Example 58, the subject matter of Examples 55-57 includes, wherein the swap ratio is calculated by dividing a quantity corresponding to a second normalized order symbol with a quantity corresponding to a first normalized order symbol.

In Example 59, the subject matter of Examples 55-58 includes, wherein matching the second normalized order to the first normalized order in the resting order book includes ensuring that a swap ratio for the second normalized order meets a swap ratio for the first normalized order.

In Example 60, the subject matter of Example 59 includes, wherein completing the first normalized order or the second normalized order includes maintaining the swap ratio of the second normalized order when decrementing and incrementing quantities in the second normalized order.

In Example 61, the subject matter of Examples 45-60 includes, wherein the indication of which of the first symbol or the second symbol is the traded asset is implicit in the first order based on symbol position in the first order.

In Example 62, the subject matter of Example 61 includes, wherein an initial position in a symbol position sequence indicates the traded asset.

In Example 63, the subject matter of Examples 45-62 includes, wherein the indication of which of the first symbol or the second symbol is the traded asset is explicitly indicated in the first order by a marker.

In Example 64, the subject matter of Examples 45-63 includes, wherein the ranking-and-matching criterion is based on an arrival time of an order.

In Example 65, the subject matter of Example 64 includes, wherein the arrival time is a secondary ranking criterion, and wherein a swap ratio is a primary ranking criterion.

In Example 66, the subject matter of Examples 64-65 includes, wherein storing the first normalized order into the resting order book includes storing an arrival time for the first order.

Example 67 is a system for swap order normalization, the system comprising: means for receiving a first order, the first order being a data structure with a first symbol, a first quantity corresponding to the first symbol, a second symbol, a second quantity corresponding to the second symbol, and an indication of which of the first symbol or the second symbol is a traded asset; means for converting the order into a first normalized order based on the indication of the traded asset, the means for converting including: means for ordering the first symbol and the second symbol to create a first normalized symbol that is less than a second normalized symbol based on an ordering criterion; means for providing a ranking-and-matching criterion; and means for indicating which of the first normalized symbol or the second normalized symbol is the traded asset; means for storing the first normalized order into a resting order book; means for receiving a second order; means for converting the second order into a second normalized order; means for matching the second normalized order to the first normalized order in the resting order book; and means for completing the first normalized order or the second normalized order, based on the matching of the second normalized order to the first normalized order, to create a completed order, a traded asset of the completed order being completely traded.

In Example 68, the subject matter of Example 67 includes, means for removing the first normalized order from the resting order book in response to completing the first normalized order, wherein the completed order is the first normalized order.

In Example 69, the subject matter of Example 68 includes, means for adjusting a traded asset quantity in the second normalized order in response to completing the first normalized order.

In Example 70, the subject matter of Example 69 includes, means for continuing to match the second normalized order against additional normalized orders in the resting order book until a stopping condition is met.

In Example 71, the subject matter of Example 70 includes, wherein the stopping condition is completion of the second normalized order.

In Example 72, the subject matter of Examples 70-71 includes, wherein the stopping condition is a failure to match the second normalized order with normalized orders remaining in the resting order book.

In Example 73, the subject matter of Example 72 includes, means for storing the second normalized order into the resting order book.

In Example 74, the subject matter of Examples 67-73 includes, wherein the first symbol is greater than the second symbol and wherein the means for ordering the first symbol and the second symbols include means for switching an order side in the first normalized order.

In Example 75, the subject matter of Example 74 includes, wherein the order type of the first order is buy and wherein the means for switching the order side include means for setting the order side of the first normalized order to sell.

In Example 76, the subject matter of Examples 74-75 includes, wherein the order type of the first order is sell and wherein the means for switching the order side include means for setting the order side of the first normalized order to buy.

In Example 77, the subject matter of Examples 67-76 includes, wherein the ranking-and-matching criterion is based on a swap ratio.

In Example 78, the subject matter of Example 77 includes, wherein the second normalized order is a buy order, and wherein a higher swap ratio is ranked higher.

In Example 79, the subject matter of Examples 77-78 includes, wherein the second normalized order is a sell order, and wherein a lower swap ratio is ranked higher.

In Example 80, the subject matter of Examples 77-79 includes, wherein the swap ratio is calculated by dividing a quantity corresponding to a second normalized order symbol with a quantity corresponding to a first normalized order symbol.

In Example 81, the subject matter of Examples 77-80 includes, wherein the means for matching the second normalized order to the first normalized order in the resting order book include means for ensuring that a swap ratio for the second normalized order meets a swap ratio for the first normalized order.

In Example 82, the subject matter of Example 81 includes, wherein the means for completing the first normalized order or the second normalized order include means for maintaining the swap ratio of the second normalized order when decrementing and incrementing quantities in the second normalized order.

In Example 83, the subject matter of Examples 67-82 includes, wherein the indication of which of the first symbol or the second symbol is the traded asset is implicit in the first order based on symbol position in the first order.

In Example 84, the subject matter of Example 83 includes, wherein an initial position in a symbol position sequence indicates the traded asset.

In Example 85, the subject matter of Examples 67-84 includes, wherein the indication of which of the first symbol or the second symbol is the traded asset is explicitly indicated in the first order by a marker.

In Example 86, the subject matter of Examples 67-85 includes, wherein the ranking-and-matching criterion is based on an arrival time of an order.

In Example 87, the subject matter of Example 86 includes, wherein the arrival time is a secondary ranking criterion, and wherein a swap ratio is a primary ranking criterion.

In Example 88, the subject matter of Examples 86-87 includes, wherein the means for storing the first normalized order into the resting order book include means for storing an arrival time for the first order.

Example 89 is at least one machine-readable medium including instructions that, when executed by processing circuitry, cause the processing circuitry to perform operations to implement of any of Examples 1-88.

Example 90 is an apparatus comprising means to implement of any of Examples 1-88.

Example 91 is a system to implement of any of Examples 1-88.

Example 92 is a method to implement of any of Examples 1-88.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1. A non-transitory machine-readable medium including instructions for order normalization, the instructions, when executed by processing circuitry, cause the processing circuitry to perform operations comprising:
receiving a first order data structure, the first order data structure including a first symbol in a Symbol1 field, a first quantity corresponding to the first symbol in a Qty1 field, a second symbol in a Symbol2 field, a second quantity corresponding to the second symbol in a Qty2 field, and an indication of which operation is requested on the first symbol in a Side field, wherein the first symbol and the second symbol are alphanumeric, and wherein the first quantity and the second quantity are numeric;
converting the first order into a first normalized order data structure, the converting including:
ordering the first symbol and the second symbol in ascending alphanumeric order such that a Symbol1 field of the first normalized order data structure value is less than a Symbol2 field of the first normalized order data structure;
providing a ranking-and-matching criterion; and
indicating that the first symbol in the Symbol1 field of the first order data structure is a traded asset in a TradedAsset field of the first normalized order data structure;
storing the first normalized order into a resting order book data structure, the resting order book data structure sorting the first normalized order based on the ranking-and-matching criterion;
receiving a second order data structure of a same format as the first order data structure with differing contents;
converting the second order data structure into a second normalized order following a procedure used to convert the first order data structure into the first normalized order data structure;
matching the second normalized order data structure to the first normalized order data structure in the resting order book data structure based on the ranking-and-matching criterion; and
completing the first normalized order data structure or the second normalized order data structure, based on the matching of the second normalized order data structure to the first normalized order data structure, to create a completed order, a traded asset of the completed order being completely traded.

2. The non-transitory machine-readable medium of claim 1, wherein the operations comprise:
removing the first normalized order data structure from the resting order book data structure in response to completing the first normalized order data structure, wherein the completed order is the first normalized order data structure.

3. The non-transitory machine-readable medium of claim 2, wherein the operations comprise:
adjusting a traded asset quantity in the second normalized order data structure in response to completing the first normalized order data structure.

4. The non-transitory machine-readable medium of claim 3, wherein the operations comprise:
continuing to match the second normalized order data structure against additional normalized order data structures in the resting order book data structure until a stopping condition is met.

5. The non-transitory machine-readable medium of claim 4, wherein the stopping condition is completion of the second normalized order data structure.

6. The non-transitory machine-readable medium of claim 4, wherein the stopping condition is a failure to match the second normalized order data structure with normalized order data structures remaining in the resting order book data structure.

7. The non-transitory machine-readable medium of claim 6, wherein the operations comprise:
storing the second normalized order data structure into the resting order book data structure.

8. The non-transitory machine-readable medium of claim 1, wherein the first symbol is greater than the second symbol under the ascending alphanumeric order and wherein ordering the first symbol and the second symbol includes:
writing the first symbol from the Symbol1 field of the first order data structure into the Symbol2 field of the first normalized order data structure;
writing the first quantity from the Qty1 field of the first order data structure into the Qty2 field of the first normalized order data structure;
writing the second symbol from the Symbol2 field of the first order data structure into the Symbol1 field of the first normalized order data structure;
writing the second quantity from the Qty2 field of the first order data structure into the Qty1 field of the first normalized order data structure; and
switching the operation requested on the first symbol by writing a value in a Side field of the first normalized order data structure that differs from the Side field of the first order data structure.

9. The non-transitory machine-readable medium of claim 8, wherein the operation requested on the first symbol is a buy and wherein switching the operation requested on the first symbol includes setting the Side field of the first normalized order data structure to sell.

10. The non-transitory machine-readable medium of claim 8, wherein the operation requested on the first symbol is a sell and wherein switching the operation requested on the first symbol includes setting the Side field of the first normalized order data structure to buy.

11. The non-transitory machine-readable medium of claim 1, wherein the ranking-and-matching criterion is based on a ratio of a value in a Qty2 field of the first normalized order data structure to a value in a Qty1 field of the first normalized order data structure, the ratio expressed as Qty2/Qty1 in a Ratio field of the first normalized order data structure.

12. The non-transitory machine-readable medium of claim 11, wherein the second normalized order data structure represents a buy order including a Side field that indicates buy, and wherein a higher ratio is ranked higher in the resting order book data structure under the ranking-and-matching criterion.

13. The non-transitory machine-readable medium of claim 11, wherein the second normalized order data structure represents a sell order including a Side field that indicates sell, and wherein a lower ratio is ranked higher in the resting order book data structure under the ranking-and-matching criterion.

14. (canceled)

15. The non-transitory machine-readable medium of claim 11, wherein matching the second normalized order data structure to the first normalized order data structure in the resting order book data structure includes ensuring that a ratio in a Ratio field of the second normalized order data structure meets a-swap the ratio in the Ratio field of the first normalized order data structure.

16. The non-transitory machine-readable medium of claim 15, wherein completing the first normalized order data structure or the second normalized order data structure includes maintaining the ratio in the Ratio field of the second normalized order data structure when decrementing or incrementing quantities in the second normalized order.

17-19. (canceled)

20. The non-transitory machine-readable medium of claim 1, wherein the ranking-and-matching criterion is based on an arrival time of an order.

21. The non-transitory machine-readable medium of claim 20, wherein the arrival time is a secondary ranking criterion, and wherein a ratio between the second quantity corresponding to the second symbol and the first quantity corresponding to the first symbol is a primary ranking criterion.

22. The non-transitory machine-readable medium of claim 20, wherein storing the first normalized order data structure into the resting order book data structure includes storing an arrival time for the first order data structure in a TimeOfReceipt field of the first normalized order data structure.

23. A method for order normalization, the method comprising:
receiving a first order data structure, the first order data structure including a first symbol in a Symbol1 field, a first quantity corresponding to the first symbol in a Qty1 field, a second symbol in a Symbol2 field, a second quantity corresponding to the second symbol in a Qty2 field, and an indication of which operation is requested on the first symbol or in a Side field, wherein the first symbol and the second symbol are alphanumeric, and wherein the first quantity and the second quantity are numeric;
converting the first order into a first normalized order data structure, the converting including:
ordering the first symbol and the second symbol in ascending alphanumeric order such that a Symbol1 field of the first normalized order data structure value is less than a Symbol2 field of the first normalized order data structure;
providing a ranking-and-matching criterion; and
indicating that the first symbol in the Symbol1 field of the first order data structure is a traded asset in a TradedAsset field of the first normalized order data structure;
storing the first normalized order into a resting order book data structure, the resting order book data structure sorting the first normalized order based on the ranking-and-matching criterion;
receiving a second order data structure of a same format as the first order data structure with differing contents;
converting the second order data structure into a second normalized order following a procedure used to convert the first order data structure into the first normalized order data structure;
matching the second normalized order data structure to the first normalized order data structure in the resting order book data structure based on the ranking-and-matching criterion; and
completing the first normalized order data structure or the second normalized order data structure, based on the matching of the second normalized order data structure to the first normalized order data structure, to create a completed order, a traded asset of the completed order being completely traded.

24. The method of claim 23, wherein the ranking-and-matching criterion is based on a ratio of a value in a Qty2 field of the first normalized order data structure to a value in a Qty1 field of the first normalized order data structure, the ratio expressed as Qty2/Qty1 in a Ratio field of the first normalized order data structure.

25. (canceled)

26. The method of claim 24, wherein matching the second normalized order data structure to the first normalized order data structure in the resting order book data structure includes ensuring that a ratio in a Ratio field of the second normalized order data structure meets the ratio in the Ratio field of the first normalized order data structure.

27. The method of claim 26, wherein completing the first normalized order data structure or the second normalized order data structure includes maintaining the ratio in the Ratio field of the second normalized order data structure when decrementing or incrementing quantities in the second normalized order.

28. The method of claim 23, wherein the first symbol is greater than the second symbol under the ascending alphanumeric order and wherein ordering the first symbol and the second symbol includes:
writing the first symbol from the Symbol1 field of the first order data structure into the Symbol2 field of the first normalized order data structure;
writing the first quantity from the Qty1 field of the first order data structure into the Qty2 field of the first normalized order data structure;
writing the second symbol from the Symbol2 field of the first order data structure into the Symbol1 field of the first normalized order data structure;
writing the second quantity from the Qty2 field of the first order data structure into the Qty1 field of the first normalized order data structure; and
switching the operation requested on the first symbol by writing a value in a Side field of the first normalized order data structure that differs from the Side field of the first order data structure.

29. The method of claim 28, wherein the operation requested on the first symbol is a buy and wherein switching the operation requested on the first symbol includes setting the Side field of the first normalized order data structure to sell.

30. The method of claim 28, wherein the operation requested on the first symbol is a sell and wherein switching the operation requested on the first symbol includes setting the Side field of the first normalized order data structure to buy.

31. The method of claim 23, wherein the ranking-and-matching criterion is based on a ratio of a value in a Qty2 field of the first normalized order data structure to a value in a Qty1 field of the first normalized order data structure, the ratio expressed as Qty2/Qty1 in a Ratio field of the first normalized order data structure.

32. The method of claim 31, wherein the second normalized order data structure represents a sell order including a Side field that indicates sell, and wherein a lower ratio is ranked higher in the resting order book data structure under the ranking-and-matching criterion.
